(19) United States
(12) Patent Application Publication
(10) Pub. No.: US 2019/0268884 A1
(43) Pub. Date: Aug. 29, 2019

(54) USER EQUIPMENT AND SIGNAL RECEIVING METHOD

(71) Applicant: NTT DOCOMO, INC., Tokyo (JP)

(72) Inventors: Yousuke Sano, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 16/344,939

(22) PCT Filed: Nov. 1, 2017
(86) PCT No.: PCT/JP2017/039610

§ 371 Date: Apr. 25, 2019

(30) Foreign Application Priority Data
Nov. 2, 2016 (JP) 2016-215710

(51) Int. Cl. H04W 72/04; H04L 1/00

(52) U.S. Cl. CPC H04W 72/042; H04L 1/0026; H04W 72/0473

(57) ABSTRACT

A user equipment which is used in a radio communication system, the user equipment including: a receiver unit configured to receive control information, which is used to acquire a desired signal from a multiplexed signal into which a plurality of user signals are multiplexed in a power domain, from a base station via a downlink physical control channel; and a desired signal acquiring unit configured to acquire the desired signal from the multiplexed signal using the control information, wherein the receiver unit receives configuration information indicating a notification method of the control information from the base station by upper layer signaling and receives the control information on the basis of the configuration information.

### TECHNICAL FIELD

The present invention relates to a radio communication system employing a system for multiplexing and transmitting a plurality of users in a power domain using the same frequency resource.

### BACKGROUND ART

Multi-user superposition transmission (MUST) in 3GPP has been studied (see Non-Patent Document 1). Non-orthogonal multiple access (NOMA) has also been studied as one of techniques included in the MUST. The NOMA is a multiple access method of causing a base station eNB (hereinafter referred to as an eNB) side to multiplex signals to a plurality of user equipments UE (hereinafter referred to as UEs) in a cell using the same frequency resource and to simultaneously transmit the signals. Accordingly, further improvement in frequency use efficiency is expected.

As a method of reducing multi-user interference in a UE performing the NOMA, application of an interference canceller of a symbol level has been studied (Non-Patent Document 1). An example of the interference canceller of a symbol level is a receiver reduced-complexity maximum likelihood determination detector (reduced complexity-ML (R-ML)).

As a NOMA transmission method, simultaneous modulation of transmission bits of the UEs has also been studied (MUST Category 2 described in Non-Patent Document 1) such that NOMA-multiplexed signal points become gray-mapping. It is possible to improve detection accuracy of a signal in a UE by Gray mapping.

### CITATION LIST

### Non-Patent Document

Non-Patent Document 1: 3GPP TR 36.859 V13.0.0 (2015-12)
Non-Patent Document 2: 3GPP TS 36.213 V13.1.1 (2016-03)
Non-Patent Document 3: 3GPP RP-160680 (2016-03)

### SUMMARY OF THE INVENTION

### Problem to be Solved by the Invention

In order for a UE to appropriately detect a NOMA-multiplexed desired signal using an interference canceller, the UE needs to ascertain control information such as information on whether simultaneous modulation is applied, a modulation scheme of an interfering user (the other user of a NOMA-multiplexed pair), a transmission rank number of an interfering user, a multiplexing power factor, and a total transmission power. However, when the control information is transmitted from the eNB to the UE using a notification method based on scheduling details of the NOMA, there is no specific conventional technique for enabling the UE to appropriately acquire the control information.

The invention is made in consideration of the above-mentioned circumstances and an object thereof is to provide a technique for enabling a user equipment to appropriately acquire control information which is used for the user equipment to acquire a desired signal from a received signal in a radio communication system in which signals of a plurality of user equipments are multiplexed and transmitted in a power domain.

### Means for Solving Problem

According to a technique disclosed herein, there is provided a user equipment which is used in a radio communication system, the user equipment including: a receiver unit configured to receive control information, which is used to acquire a desired signal from a multiplexed signal into which a plurality of user signals are multiplexed in a power domain, from a base station via a downlink physical control channel; and a desired signal acquiring unit configured to acquire the desired signal from the multiplexed signal using the control information, wherein the receiver unit receives configuration information indicating a notification method of the control information from the base station by upper layer signaling and receives the control information on the basis of the configuration information.

### Effect of the Invention

According to the disclosed technique, it is possible to provide a technique for enabling a user equipment to appropriately acquire control information which is used for the user equipment to acquire a desired signal from a received signal in a radio communication system in which signals of a plurality of user equipments are multiplexed and transmitted in a power domain.

### BRIEF DESCRIPTION OF DRAWINGS

FIG. 1 is a diagram illustrating a fundamental principle of NOMA;

FIG. 2A is a diagram illustrating a fundamental principle of the NOMA;

FIG. 2B is a diagram illustrating a fundamental principle of the NOMA;

FIG. 2C is a diagram illustrating a fundamental principle of the NOMA;

FIG. 3A is a diagram illustrating an example of signal points in the NOMA;

FIG. 3B is a diagram illustrating an example of signal points in the NOMA;

FIG. 4 is a diagram illustrating P_{A} and P_{B};

FIG. 5 is a diagram illustrating a total transmission power in an eNB;

FIG. 6 is a diagram illustrating an example of a configuration of a radio communication system according to an embodiment of the invention;

FIG. 7 is a diagram illustrating a basic operation in the embodiment;

FIG. 8 is a flowchart illustrating an example of a receiving operation of a UE;

FIG. 9 is a diagram illustrating a parameter notification method according to Example 1;

FIG. 10 is a diagram illustrating a parameter notification method according to Example 2;

FIG. 11 is a diagram illustrating a parameter notification method according to Example 3;

FIG. 12 is a diagram illustrating an example of a power factor at which simultaneous modulated signal points are arranged at equal intervals in Example 3;

FIG. 13 is a diagram illustrating a parameter notification method according to Example 4;

FIG. 14 is a diagram illustrating a parameter notification method according to Example 5;

FIG. 15 is a diagram illustrating a parameter notification method according to Example 6;

FIG. 16 is a diagram illustrating an example of a table in Example 6;

FIG. 17A is a diagram illustrating a problem in Example 7;

FIG. 17B is a diagram illustrating a problem in Example 7;

FIG. 18 is a diagram illustrating an example of DCI of options;

FIG. 19 is a diagram illustrating a parameter notification method according to Example 7-1;

FIG. 20 is a diagram illustrating a parameter notification method according to Example 7-2;

FIG. 21 is a diagram illustrating a parameter notification method according to Example 7-3;

FIG. 22 is a diagram illustrating an example of information indicating Option 2/3;

FIG. 23 is a diagram illustrating determination based on capability information;

FIG. 24 is a block diagram illustrating a functional configuration of a UE;

FIG. 25 is a block diagram illustrating a functional configuration of an eNB;

FIG. 26 is a block diagram illustrating a functional configuration of an eNB and a UE; and

FIG. 27 is a block diagram illustrating HW configurations of an eNB and a UE.

### MODES FOR CARRYING OUT THE INVENTION

Hereinafter, embodiments of the invention will be described with reference to the accompanying drawings. The embodiments to be described below are only examples and embodiments of the invention are not limited to the below-described embodiments. For example, a radio communication system according to the embodiments is assumed to be an LTE-based system, but the invention is not limited to the LTE and can be applied to another scheme. In the specification and the appended claims, “LTE” is used in a wide meaning including communication schemes (which include 5G) corresponding to Releases 8 to 14 of 3GPP, unless otherwise specified.

Downlink (DL) NOMA is used as an example of a system for multiplexing and transmitting a plurality of users in a power domain using the same frequency resource, but the invention can be applied to a system other than the NOMA. In this embodiment, data signals (physical downlink shared channel (PDSCH) signals in the LTE in this embodiment) are used as signals to be NOMA-multiplexed, but the invention is not limited to the data signals and can be applied to other signals.

In the embodiments of the invention, terms such as UE, eNB, PDSCH, PDCCH, SIB, RRC, and DCI which have been used in the existing LTE are used, but these terms are used for the purpose of convenience and may be referred to as other names having the same functions.

(NOMA)

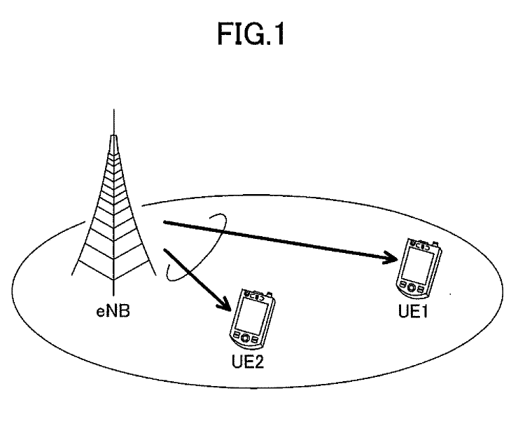

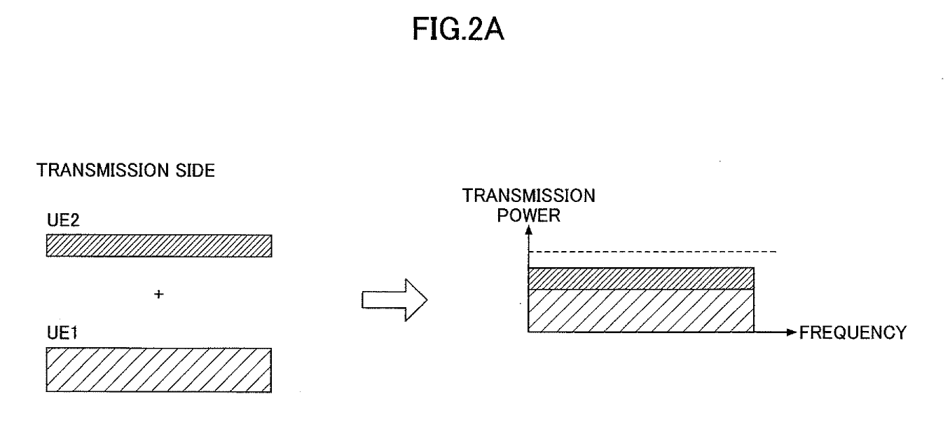

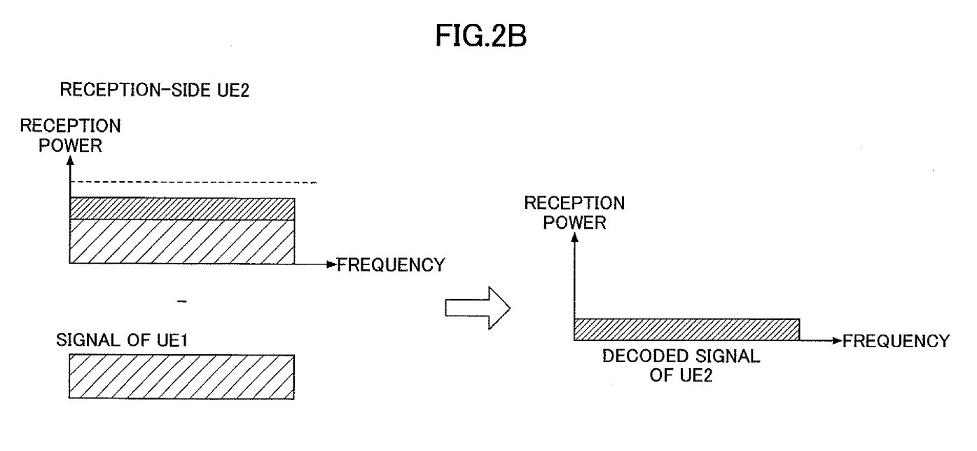

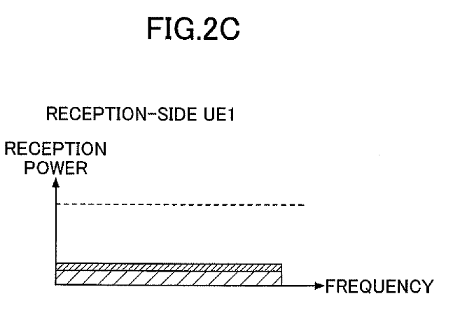

As described above, since NOMA is used in this embodiment, fundamental principles in a NOMA downlink will be described below with reference to FIGS. 1 and 2. FIG. 1 illustrates a user equipment UE2 (a near UE or a center UE) near a base station eNB and a user equipment UE1 (a far UE or an edge UE) near a cell edge.

The eNB selects the UE1 and the UE2 as a pair and multiplexes a signal of the UE1 and a signal of the UE2 using the same frequency resource and simultaneously transmits the multiplexed signal as illustrated in FIG. 2A. At this time, a large power is allocated to the UE1 at the cell edge and a small power is allocated to the UE2 near the cell center. Multiplexing with two UEs as a pair is only an example, and signals of three or more UEs may be multiplexed.

A signal to the UE1 and a signal to the UE2 are multiplexed and reach the UE2 near the cell center, and the signal to the UE2 can be decoded by removing the signal to the UE1 by an interference cancelling process as illustrated in FIG. 2B. On the other hand, regarding the UE1 at the cell edge, since a small power is allocated to the signal to the UE2 serving as interference with the UE1, the signal to the UE2 is much weakened as illustrated in FIG. 2C. Accordingly, the UE1 can decode the signal to the UE1 directly without performing the interference cancelling process. As described above, multiplexing in the power domain is performed in the NOMA, but the technique of performing multiplexing in the power domain is not limited to the NOMA.

The MIMO introduced into the LTE system and the NOMA may be combined and it is thus possible to further improve system performance. In the downlink MIMO defined in the LTE, precoding (adjustment of phase and amplitude) is used to improve a reception SINR and a precoded signal is applied to antennas.

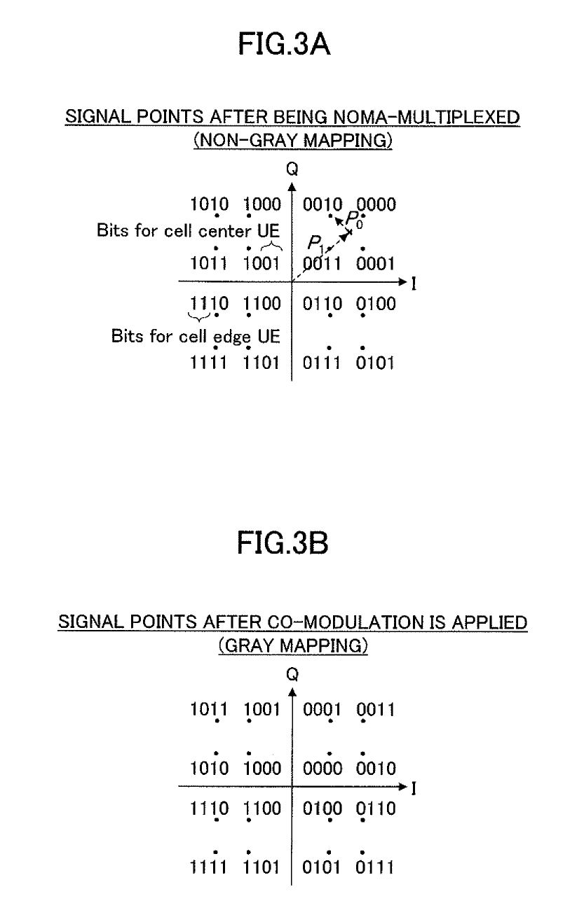

As described above, simultaneous modulation of transmission bits of the UEs has been studied to gray-map NOMA-multiplexed signal points. FIGS. 3A and 38 are diagrams illustrating NOMA-multiplexed signal points when a modulation scheme of the user equipments is QPSK. FIG. 3A illustrates an example in which simultaneous modulation is not applied and FIG. 3B illustrates an example of simultaneous modulation is applied for gray mapping. Simultaneous modulation in this embodiment means that information bits of a plurality of user equipments (four bits in the case of two user equipments and the QPSK) are jointly mapped on a signal point and are modulated to achieve gray mapping.

(Example of Signal Model of NOMA)

An example of a signal model of the NOMA will be described below. First, symbols in expressions have the following meanings.

y: Received signal

H: Channel matrix

wi: Precoder matrix for stream i

gi: H×wi (equivalent channel)

p: Power factor for NOMA

s: Trans. symbol for cell center UE (transmission signal of center LIE)

i: Trans. symbol for cell edge UE (transmission signal of cell edge UE)

n: Noise vector

The following expression represents a received signal when the number of rank of both the center UE and the edge UE is 1.

$$\begin{matrix}y = {Hw}_{1} \sqrt{p} s + {Hw}_{1} \sqrt{1 - p} i + n \\ = g ( \sqrt{p } s + \sqrt{1 - p} i ) + n\end{matrix} \qquad [ Expression 1 ]$$

The following expression represents a received signal when the rank number of the center UE is 2 and the rank number of the edge UE is 1.

$$\begin{matrix}y = H [ {w}_{1} {w}_{2} ] \sqrt{p} [ \begin{matrix}{s}_{1} \\ {s}_{2}\end{matrix} ] + H \sqrt{2} {w}_{1} \sqrt{1 - p} i + n \\ = [ {g}_{1} {g}_{2} ] [ \begin{matrix}\sqrt{p } {s}_{1} + \sqrt{2 ( 1 - p )} i \\ \sqrt{p} {s}_{2}\end{matrix} ] + n\end{matrix} \qquad [ Expression 2 ]$$

The following expression represents a received signal when the rank numbers of both the center UE and the edge UE are 2.

$$\begin{matrix}y = H [ {w}_{1} {w}_{2} ] \sqrt{p} [ \begin{matrix}{s}_{1} \\ {s}_{2}\end{matrix} ] + H [ {w}_{1} {w}_{2} ] \sqrt{1 - p} [ \begin{matrix}{i}_{1} \\ {i}_{2}\end{matrix} ] + n \\ = [ {g}_{1} {g}_{2} ] [ \begin{matrix}\sqrt{p } {s}_{1} + \sqrt{1 - p} {i}_{1} \\ \sqrt{p } {s}_{2} + \sqrt{1 - p} {i}_{2}\end{matrix} ] + n\end{matrix} \qquad [ Expression 3 ]$$

(Transmission Power of eNB in NOMA)

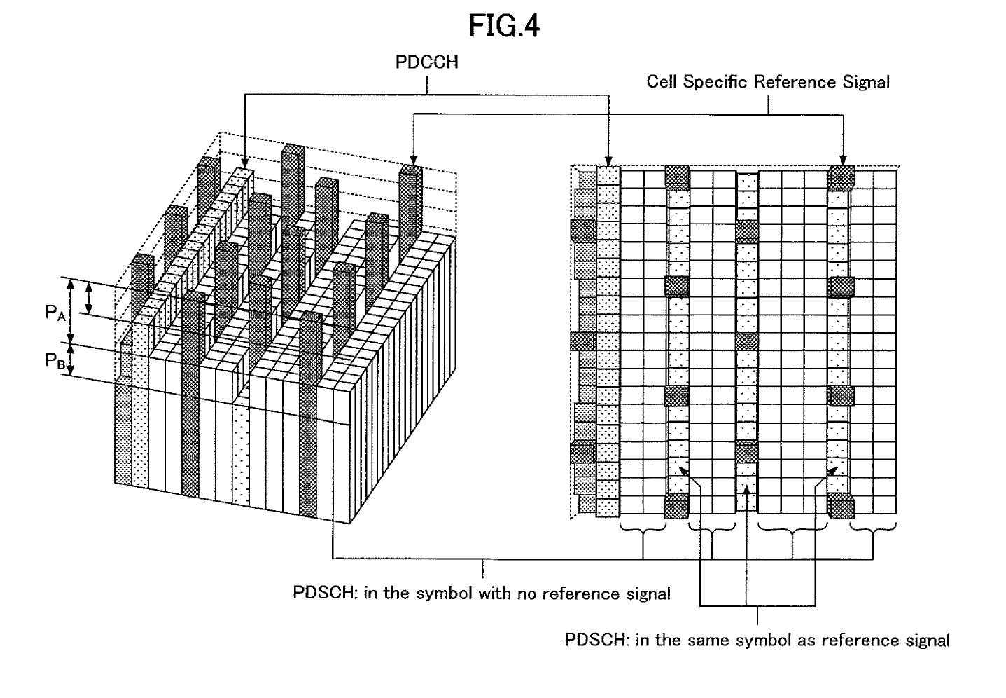

As described above, a channel in which NOMA multiplexing is performed in this embodiment is a PDSCH for transmitting a data signal. Here, the transmission power of the PDSCH is controlled by parameters P_{A} and P_{B} (Non-Patent Document 2). As illustrated in FIG. 4, P_{A} denotes a power offset between a reference signal and a PDSCH in a symbol without the reference signal. P_{B} denotes a power offset between a PDSCH in a symbol with the reference signal and a PDSCH in a symbol without the reference signal. The UE can ascertain the transmission power of the PDSCH when the UE knows P_{A} and P_{B}. Here, P_{B} is specific to the cell and is broadcasted using SIB2. On the other hand, P_{A} is specific to the UE and is broadcasted using upper layer signaling. That is, P_{A} can be generally said to be power information corresponding to the transmission power of a desired signal.

Since P_{A} is specific to the UE as described above, it is assumed that the value of P_{A} is different between the UEs which are NOMA-multiplexed in an operation type in which a plurality of P_{A}s are used in the same cell.

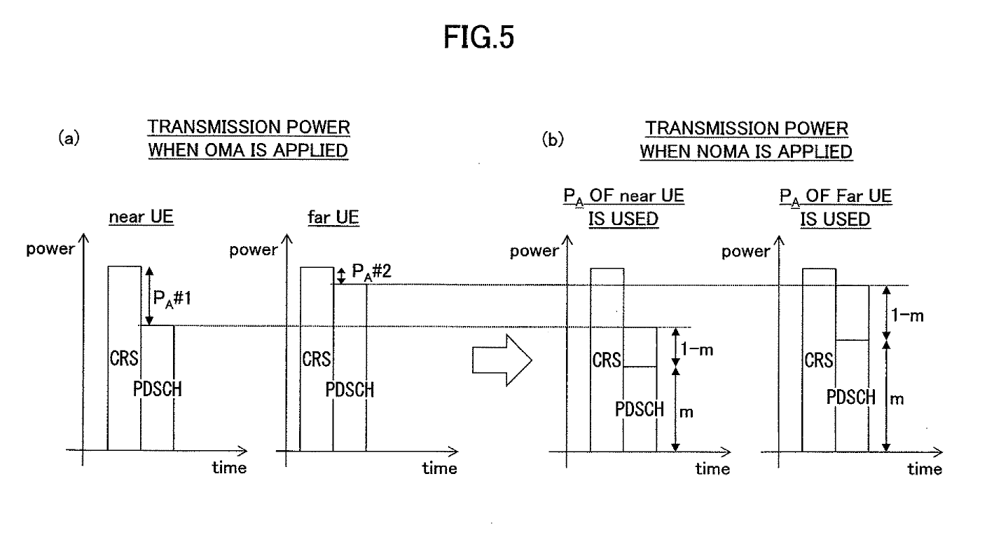

Here, control information required for the UE to appropriately detect a signal of a PDSCH after being NOMA-multiplexed is as follows. When the control information is predetermined as will be described later, when the control information can be estimated, and the like, notification of the control information may not be performed.
Information on whether simultaneous modulation is applied or not
Modulation scheme of an interfering user
Information of presence or absence of interference for each layer (or a transmission rank number of an interfering user)
Transmission mode (TM)
NOMA-multiplexing power factor (m in FIG. 5(b))
Total transmission power after being NOMA-multiplexed (the value of P_{A} in FIG. 5(a))

Regarding the total transmission power, when the UEs having different P_{A} are NOMA-multiplexed, the method of selecting the total transmission power in the eNB is not unique. A problem in this case will be described below with reference to FIGS. 5(a) and 5(b).

FIG. 5(a) illustrates a difference in transmission power of the PDSCHs due to an assumed P_{A} difference between a near UE and a far UE when an orthogonal multiple access (OMA) is applied. FIG. 5(b) illustrates the transmission power of the PDSCHs when the NOMA is applied to the near UE and the far UE.

The left drawing of FIG. 5(b) illustrates a case in which P_{A} of the near UE is used, and the right drawing of FIG. 5(b) illustrates a case in which P_{A} of the far UE is used. When the P_{A} of the near UE is used and P_{A}#1 is not signaled to the far UE, there is a possibility that signal detection accuracy of the far UE will degrade particularly in the case of high-order modulation (such as 16 QAM). On the other hand, when P_{A}#2 is not signaled to the near UE, there is similarly a possibility that signal detection accuracy of the near UE will degrade in the case of high-order modulation (such as 16 QAM).

In this embodiment, there is provided a technique for enabling a UE to appropriately acquire control information which is used for the UE to appropriately detect a NOMA-multiplexed PDSCH signal in consideration of the above-mentioned problem. Since the control information is information which is used to cancel interference when another UE which is NOMA-multiplexed with the UE is considered as an interference source (interfering UE), the control information may be referred to as interference information. Hereinafter, the technique will be described in detail.

(System Configuration and Basic Operation)

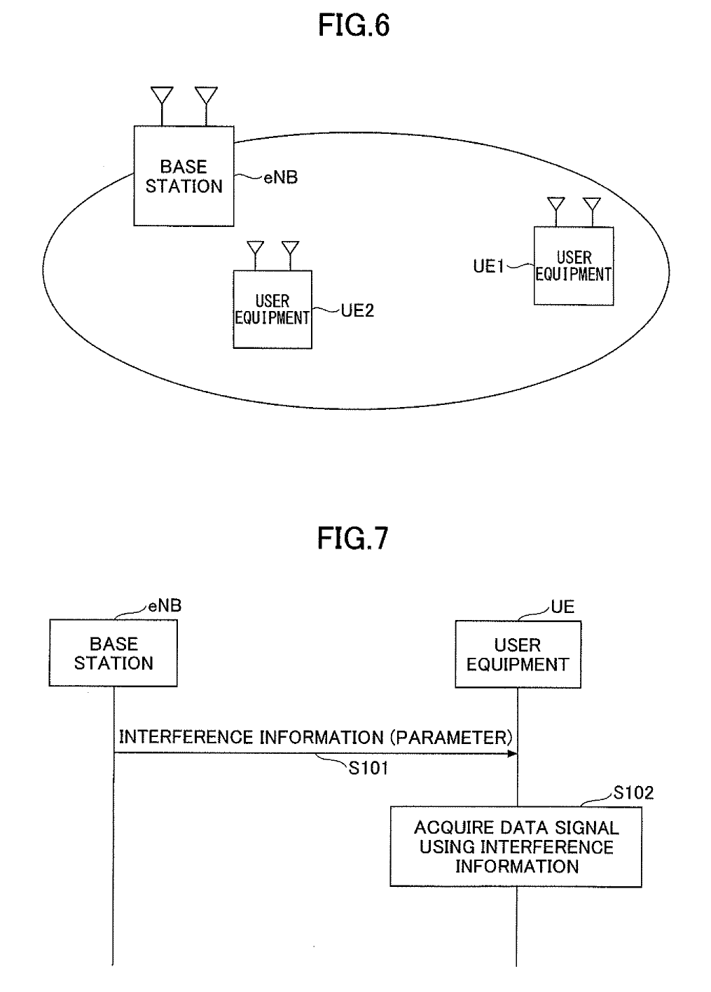

FIG. 6 is a diagram illustrating a configuration of a radio communication system according to an embodiment. As illustrated in FIG. 6, the radio communication system according to this embodiment includes a base station eNB (hereinafter referred to as an eNB), a user equipment UE2 (hereinafter referred to as a UE2) near to the eNB, and a user equipment UE1 (hereinafter referred to as a UE1) at a cell edge. The eNB and the UEs have at least an LTE function and have a function of performing non-orthogonal multiple access (NOMA) using MIMO.

As described above, the NOMA is a multiple access method of causing the eNB side to multiplex signals to a plurality of UEs in a cell using the same resource and to simultaneously transmit the signals and multiplexes signals of the user equipments in a power domain. Separation of the user signals multiplexed in the power domain is performed by power distribution between the user equipments constituting a pair and application of an interference cancelling function in the UEs. The technique of performing multiplexing in the power domain is not limited to the NOMA.

A plurality of UEs are present in a cell of an eNB, but FIG. 6 illustrates two UEs (a UE1 and a UE2) of a pair selected as a multiplexing target in the power domain by the eNB. That is, the eNB receives CQI from the UEs and the UE1 and the UE2 are selected as a pair selection result based on the received CQI of the UEs. The power factor is also determined at the time of selecting the pair.

In the radio communication system according to this embodiment, the operation illustrated in FIG. 7 is basically performed. That is, the eNB broadcasts interference information to the UE (Step S101). The UE acquires a desired data signal (a signal of a PDSCH) from a NOMA-multiplexed received signal using the interference information (Step S102).

As described above, the interference information in this embodiment includes, for example, the following information.
Information on whether simultaneous modulation is applied or not
Modulation scheme of an interfering user
Transmission rank number of an interfering user (or information on presence or absence of interference for each layer)
Transmission mode (TM)
NOMA-multiplexing power factor
Total transmission power after being NOMA-multiplexed

Here, it is not necessary to notify of the whole above-mentioned information as the interference information from the eNB to the UE. Regarding information not transmitted from the eNB to the UE, the UE may use a predetermined fixed value or may use its own information on the assumption that the information is the same as its own (the UE's) information. When the information can be estimated by blind detection, the information may be estimated.

As the notification method of transmitting information from the eNB to the OR, one or both of semi-static signaling using an RRC message (which may also be referred to as upper layer signaling) and dynamic signaling using DCI transmitted by a PDCCH can be used. The eNB may transmit candidates of the interference information to the OE using RRC in advance and the UR may specify the information by blind detection. The eNB may transmit candidates of the interference information to the UE using RRC and the UE may specify the information by dynamic signaling.

Conclusively, this embodiment has the following variations of the notification method (an acquisition method in a OE) for the above-mentioned interference information.
A prescribed fixed value is used;
The same information as its own information is assumed (it is assumed that the interference information is the same as information of the desired signal);
Semi-static signaling using RRC;
Dynamic signaling using DCI;
Blind detection;
Candidates are notified in advance using RRC and the interference information is specified by blind detection;
Candidates are notified in advance using RRC and the interference information is specified by dynamic signaling.

In this embodiment, the interference information is notified using one or more of the above-mentioned notification methods. Specific examples of the notification method will be described later.

(Data Signal Acquiring Operation of UE Using Interference Information)

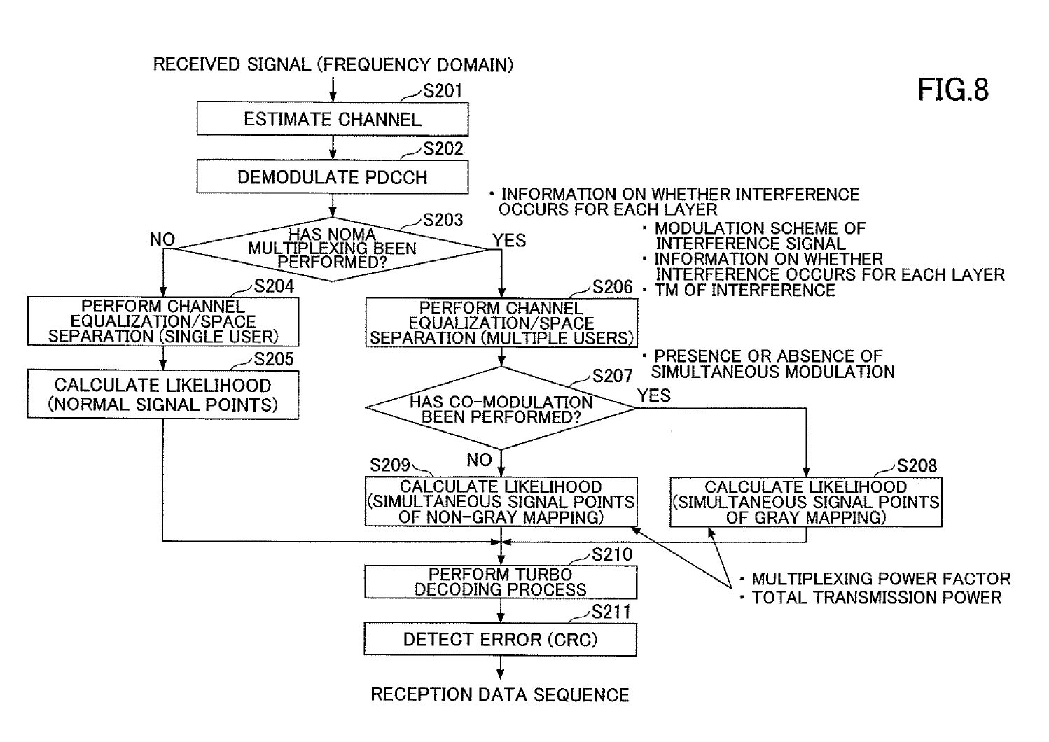

An operation example in which a UE acquires a desired (its own) data signal from a NOMA-multiplexed signal using the interference information will be described with reference to the flowchart illustrated in FIG. 8. This example is an operation example in which a receiver reduced-complexity maximum likelihood determination detector (R-ML) is applied. In the following example, the UE may store the interference information which has been already acquired or may acquire the interference information using the PDCCH (DCI) in Step S202.

The UE performs channel estimation on the basis of a received signal from the eNB (Step S201) and demodulates the PDCCH (Step S202). In Step S203, the UE determines whether a data signal (a PDSCH) is NOMA-multiplexed on the basis of the information on presence or absence of interference for each layer (which includes a case in which there is only one layer). Step S204 is performed when the determination result is NO (when no interference occurs in any layer, that is, when NOMA multiplexing is not performed), and Step S206 is performed when the determination result is YES (when there is interference in some layers, that is, when NOMA multiplexing is performed).

When it is determined in Step S204 that NOMA multiplexing is not performed (when a single user is present), the UE performs channel equalization/space separation of the PDSCH and calculates likelihoods of normal signal points to estimate a received signal (Step S205).

When it is determined that NOMA multiplexing is performed (when multi-users are present) in Step S206, the UE performs channel equalization/space separation of the PDSCH using the modulation scheme of the interference signal, information on whether interference occurs for each layer, and the TM of the interference signal.

In Step S207, the UE determines whether simultaneous modulation is performed on the basis of information on presence or absence of simultaneous modulation. Step S208 is performed when the determination result is YES (when simultaneous modulation is performed), and Step S209 is performed when the determination result is NO (when simultaneous modulation is not performed).

In Step S208, the UE calculates likelihoods of simultaneous signal points of gray mapping to estimate a received signal using the multiplexing power factor and the total transmission power. In Step S209, the UE calculates likelihoods of simultaneous signal points of non-gray mapping to estimate a received signal using the multiplexing power factor and the total transmission power.

Then, a turbo decoding process is performed (Step S210), error detection (CRC) is performed (Step S211), and a desired reception data sequence is acquired.

Examples 1 to 7 of the interference information (parameter) notification method will be described below.

### Example 1

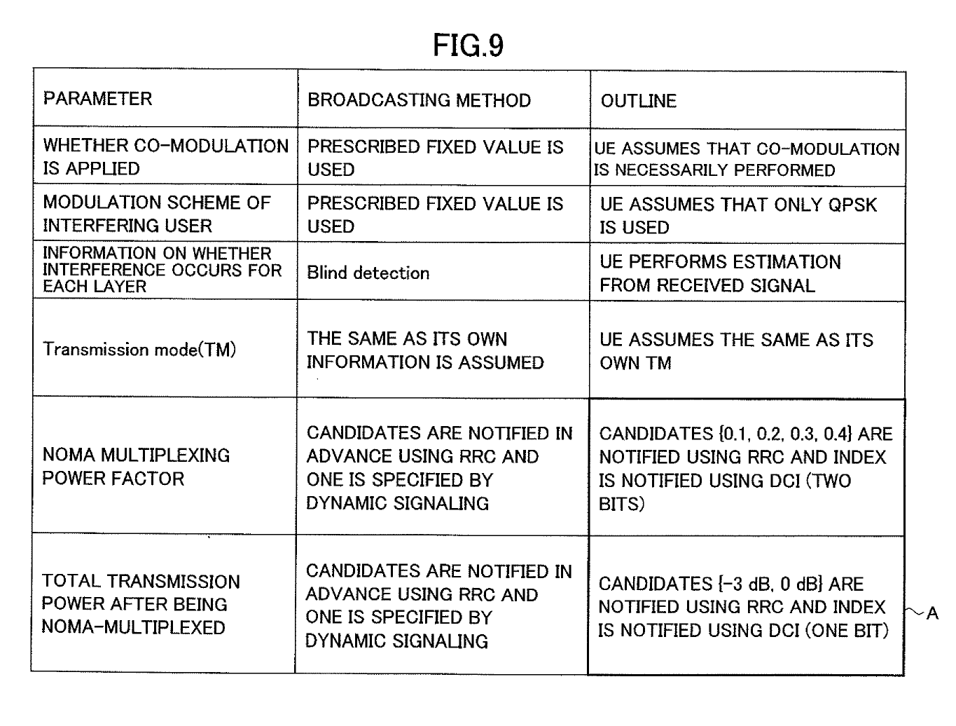

First, Example 1 will be described. FIG. 9 is a diagram illustrating parameter notification methods according to Example 1 and operation examples of a UE side corresponding to the notification methods.

In Example 1, a UE uses a prescribed fixed value as the information on presence or absence of application of simultaneous modulation. For example, the UE assumes that simultaneous modulation is necessarily performed in NOMA multiplexing. A prescribed fixed value is used for the modulation scheme of an interfering user. For example, the UE assumes that the modulation scheme of an interfering user is only QPSK.

The UE estimates the information on whether interference occurs for each layer (stream) from the received signal by blind detection. The information on whether interference occurs for each layer is information on whether interference occurs in Layer 1 or whether interference occurs in Layer 2 when Layer 1 and Layer 2 are present as layers (streams) of receiving the PDSCH in the UE. “Interference occurs (there is interference)” means that a data signal of another UE is NOMA-multiplexed. Regarding estimation of whether interference occurs, it can be estimated that interference occurs when the signal point of the received signal is close to the signal points illustrated in FIGS. 3A and 3B and it can be estimated that interference does not occur when the signal point of the received signal is not close to the signal points (when the signal point is close to normal signal points), for example, in the case of QPSK.

The transmission mode (TM) of an interfering user is assumed to be the same as its own information. For example, when the TM of its received signal is TM4, the UE estimates that the TM of the interfering user is also TM4.

Regarding the NOMA multiplexing power factor (ratio), candidates thereof are notified from the eNB to the UE in advance using RRC and the UE specifies the multiplexing power factor by dynamic signaling. For example, the eNB transmits candidates of the multiplexing power factor {0.1, 0.2, 0.3, 0.4} using RRC signaling and an index indicating a specific candidate in two bits using DCI. Here, the multiplexing power factor may be a multiplexing power factor of the UE or may be a multiplexing power factor of another UE which is multiplexed. Which to use can be determined in advance.

Regarding the total transmission power after being NOMA-multiplexed, candidates thereof are notified from the eNB to the UE in advance using RRC and the UE specifies a specific candidate by dynamic signaling. For example, the eNB transmits candidates {−3 dB, 0 dB} to the UE using RRC and transmits an index indicating a specific candidate to the UE in one bit using DCI. The candidates {−3 dB, 0 dB} are examples in which the eNB notifies of P_{A} used in a cell as a candidate. The value which is notified as information of the total transmission power may be P_{A} or may be the transmission power of a PDSCH. Regarding details indicated by A in FIG. 9, the UE performs, for example, the following operation in Example 1.

That is, when candidates are not notified using the RRC signaling, the UE determines that these bits (2+1=3 bits) are not included in the DCI and decodes a PDCCH. When candidates are notified using the RRC signaling, the UE determines that these bits (2+1=3 bits) are added to the DCI and decodes a PDCCH. For example, when the DCI to which the bits are not added has X bits, the DCI to which three bits are added has (X+3) bits and the UE determines that the DCI has (X+3) bits and performing the decoding process.

### Example 2

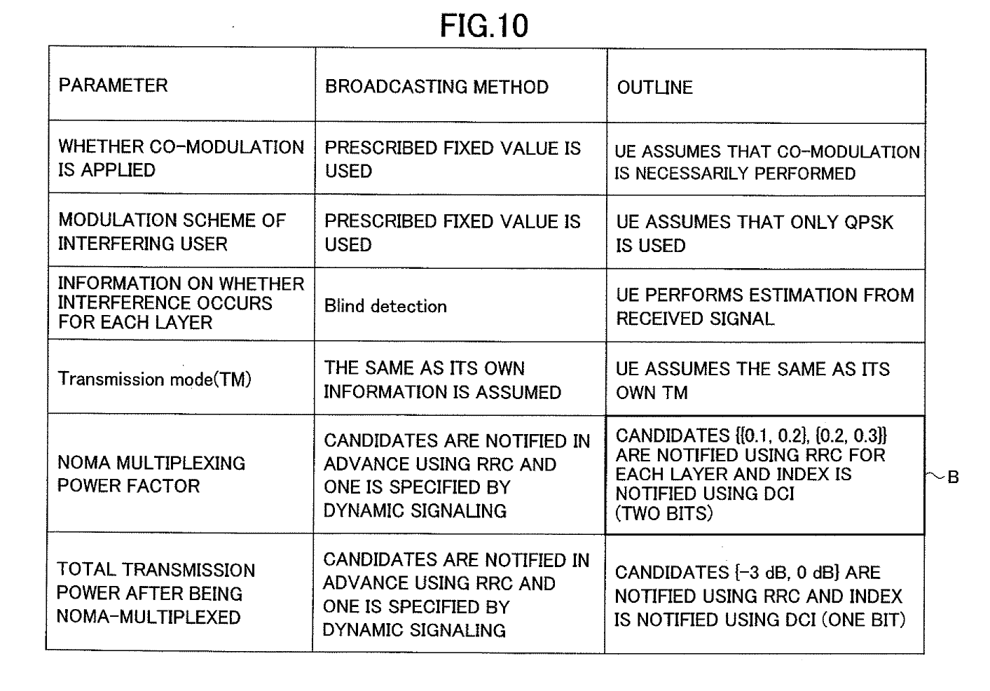

Example 2 will be described below. FIG. 10 is a diagram illustrating parameter notification methods according to Example 2 and operation examples of a UE side corresponding to the notification methods. Example 2 is different from Example 1, in examples of the notification method of the NOMA multiplexing power factor. The other details are the same as in Example 2.

Regarding the notification method of the NOMA multiplexing power factor, in Example 2, the eNB transmits candidates for each layer {{0.1, 0.2}, {0.2, 0.3}} to the UE using the RRC signaling and transmits an index indicating a specific value in two bits using the DCI.

### Example 3

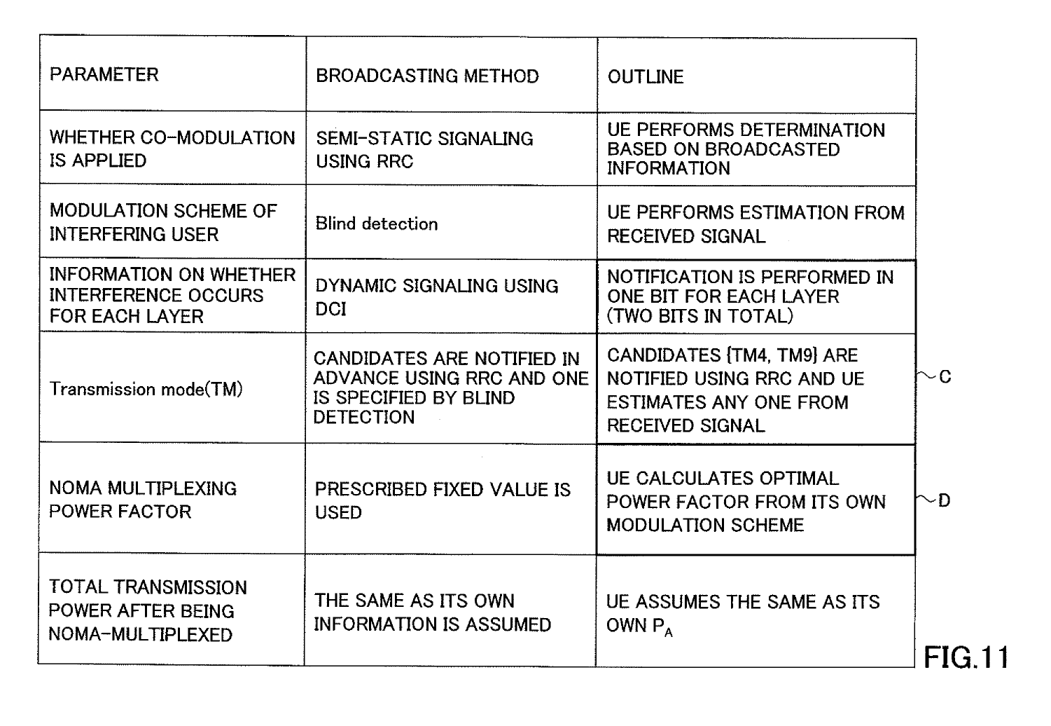

Example 3 will be described below. FIG. 11 is a diagram illustrating parameter notification methods according to Example 3 and operation examples of a UE side corresponding to the notification methods.

In Example 3, the eNB transmits information on presence or absence of simultaneous modulation to the UE by semi-static signaling using RRC. Then, the UE determines whether simultaneous modulation is applied on the basis of the notified information.

The UE estimates the modulation scheme of an interfering user from the received signal by blind detection. As the estimation method, for example, a method of receiving a signal on the assumption of possible modulation schemes and estimating that a most possible modulation scheme is the modulation scheme of an interfering user can be used.

The information on whether interference occurs for each layer is notified from the eNB to the UE by dynamic signaling using DCI. For example, the eNB notifies of the information by one bit for each layer (two bits in total).

Regarding the transmission mode (TM), the eNB transmits candidates to the UE using RRC signaling and the UE specifies a TM of an interfering user by blind detection. For example, the eNB transmits candidates {TM4, TM9} to the UE using RRC signaling and the UE estimates any one thereof from the received signal. As the estimation method, for example, a method of receiving a signal on the assumption of possible TM candidates and estimating that a most possible TM candidate is the TM of an interference signal can be used.

A prescribed fixed value is used as the NOMA multiplexing power factor. For example, the UE calculates the optimal power factor from its own modulation scheme.

The total transmission power after being NOMA-multiplexed is assumed to be the same as its own information. For example, the UE assumes that P_{A} of an interfering UE is the same as its own P_{A} (P_{A} which is not for NOMA but is individually notified to the UE). Regarding the total transmission power after being NOMA-multiplexed, the UE performs the operation of Examples 1 and 2 when the total transmission power is notified using RRC signaling described in Examples 1 and 2 and may perform the operation of Example 3 when the total transmission power is not notified.

Regarding details indicated by C in FIG. 11, for example, the UE may perform the following operation.

That is, when TM candidates are not notified from the eNB using RRC signaling, the UE determines that additional bits (two bits) are not added to the DCI and decodes the PDCCH. In this case, the UE decodes a PDSCH on the premise that NOMA multiplexing is not performed.

When TM candidates are notified from the eNB using RRC signaling, the UE determines that these bits (two bits) are added to the DCI and decodes the PDCCH. Then, the UE determines that a layer of which the bit is 1 is NOMA-multiplexed and decodes the PDSCH. The UE determines that a layer of which the bit is 0 is not NOMA-multiplexed and decodes the PDSCH. The meaning of the bit I/O is an example. The meanings of 1 and 0 may be reversed.

Regarding details indicated by D in FIG. 11, in a specific example, the UE calculates the optimal power factor on the premise that a QPSK signal is multiplexed to its own modulation scheme. Here, since the power factor in which simultaneous-modulated signal points (for example, FIG. 3(b)) are arranged in equal intervals is unique, the UE calculates the power factor such that simultaneous-modulated signal points are arranged in equal intervals as the optimal power factor.

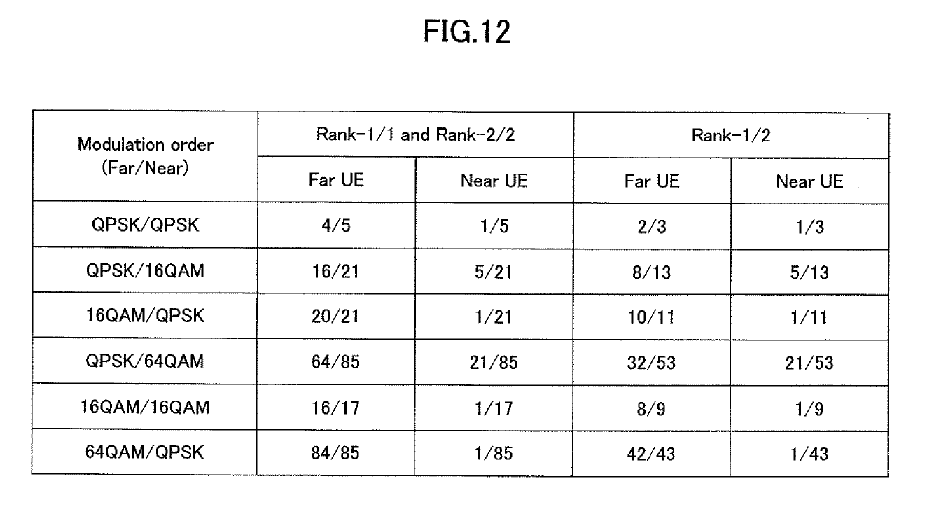

As illustrated in FIG. 12, the optimal power factor for each combination of layers of a far UE and a near UE may be stored as a table in the UE and the UE may acquire the power factor by reading a value from the table. The UE can determine that the UE is a near UE when the power factor signaled from the eNB to the UE is equal to or less than 0.5 and the UE is a far UE when the power factor is greater than 0.5.

In FIG. 12, Rank-1/1 indicates that the rank numbers of both the far UE and the near UE are 1, and Rank-2/2 indicates that the rank numbers of both the far UE and the near UE are 2. Rank-1/2 indicates that the rank number of the far UE is 1 and the rank number of the near UE is 2. In the example illustrated in FIG. 12, it is assumed that the power factors are the same in the layers of the same UE.

### Example 4

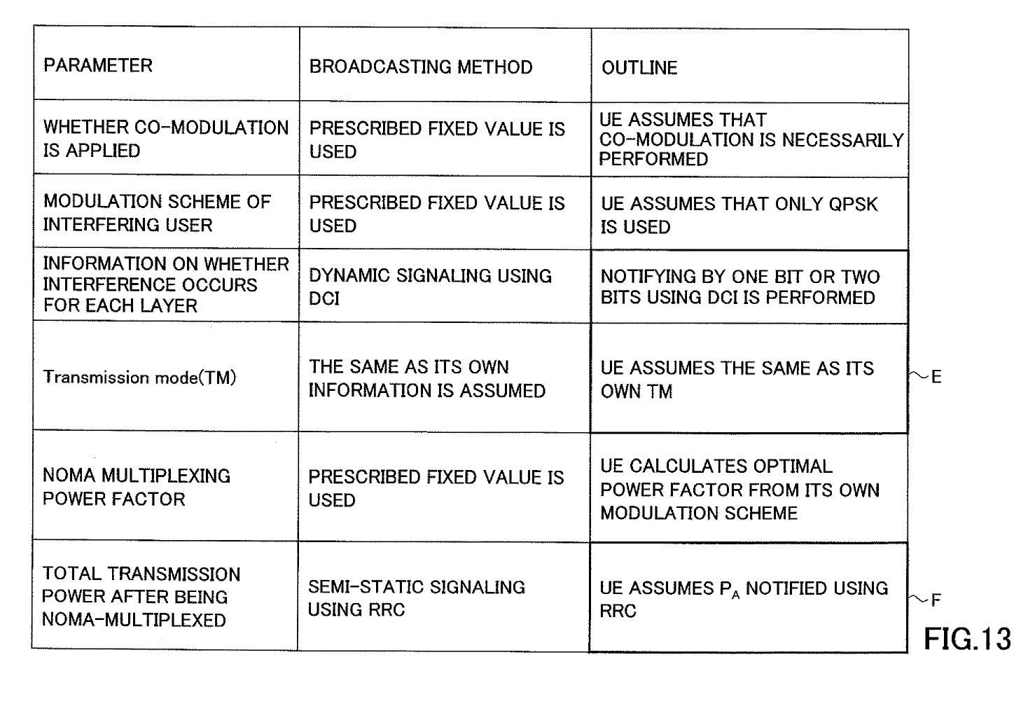

Example 4 will be described below. FIG. 13 is a diagram illustrating parameter notification methods according to Example 4 and operation examples of a UE side corresponding to the notification methods.

In Example 4, the information on whether simultaneous modulation is applied, the modulation scheme of an interfering user, and the transmission mode are the same as in Examples 1 and 2. The NOMA multiplexing power factor is the same as in Example 3.

In Example 4, the information on whether interference occurs for each layer is notified from the eNB to the UE by dynamic signaling using DCI. For example, the eNB transmits the information on presence or absence of interference for each layer by one bit or two bits using DCI.

The total transmission power after being NOMA-multiplexed is notified from the eNB to the UE using RRC signaling. The UE uses P_{A} notified using the RRC signaling for NOMA.

Regarding details indicated by E and F in FIG. 13, more specifically, the UE performs, for example, the following operation.

That is, when P_{A} for NOMA is not notified using RRC signaling, the UE determines that there is no additional bit (one bit or two bits) to DCI and decodes a PDCCH. Then, the UE decodes a PDSCH on the premise that NOMA multiplexing is not performed.

When P_{A} for NOMA is notified using RRC signaling and when its own TM is TM2 or TM3, the UE determines that one bit is added to DCI and decodes a PDCCH. This is an operation based on the fact that NOMA multiplexing is not performed when the number of layers differs between the UEs in TM2 or TM3. That is, when P_{A} for NOMA is notified using RRC signaling, it can be estimated that NOMA multiplexing is performed. In this case, it is estimated that the number of layers of the UE and the number of layers of the interfering UE are the same.

When the bit is 1, the UE determines that all layers are NOMA-multiplexed and decodes the PDSCH. When the bit is 0, the UE determines that no layer is NOMA-multiplexed and decodes the PDSCH.

When the TM of the UE is other than TM2 and TM3, the UE determines that two bits (for each layer) are added to DCI and decodes the PDCCH. In this case, the UE determines that a layer of which the bit is 1 is NOMA-multiplexed and decodes the PDSCH. The UE determines that a layer of which the bit is 0 is not NOMA-multiplexed and decodes the PDSCH.

The meaning of the bit I/O is an example. The meanings of 1 and 0 may be reversed.

### Example 5

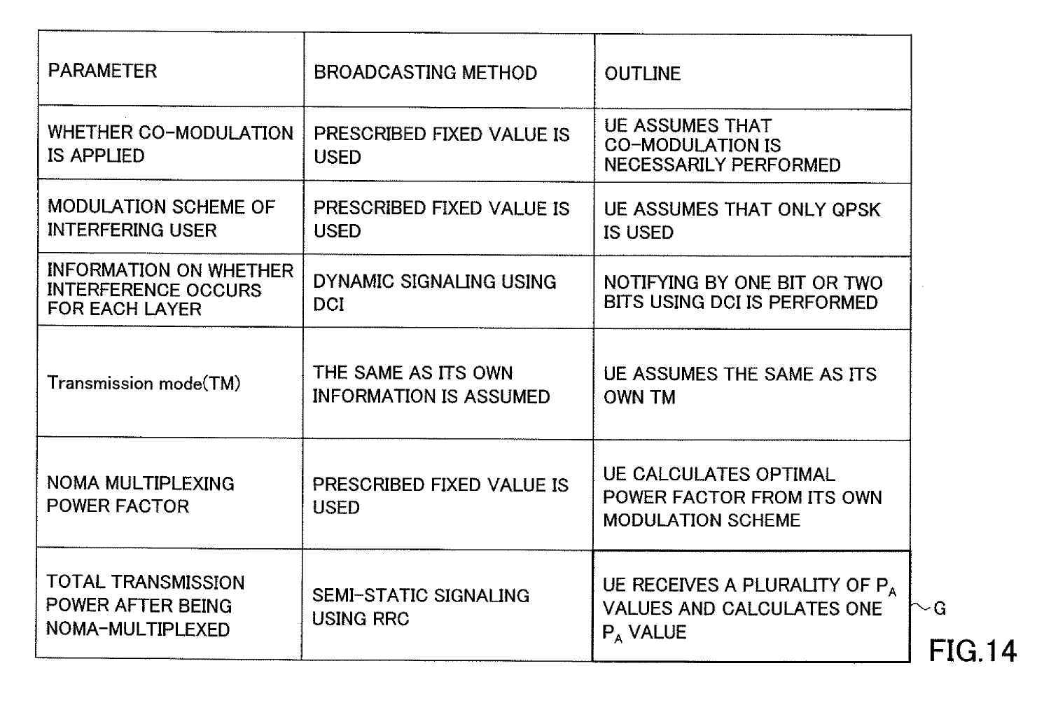

Example 5 will be described below. FIG. 14 is a diagram illustrating parameter notification methods according to Example 5 and operation examples of a UE side corresponding to the notification methods. Example 5 is basically the same as in Example 4. Example 5 is different from Example 4, in the operation example of a UE side in the method of notifying of the total transmission power after being NOMA-multiplexed. The other details are the same as in Example 4.

In Example 5, regarding the notification method of the total transmission power after being NOMA-multiplexed, the UE receives a plurality of P_{A} values from the eNB and calculates and uses one P_{A} value from the plurality of P_{A} values.

Specifically, for example, the UE calculates one P_{A} value from the plurality of P_{A} values (for example, P_{A} for each NOMA user) notified from the eNB. Examples of the calculation method include averaging and weighted averaging, but the calculation method is not limited thereto. For example, the P_{A} value may be calculated by addition, subtraction, or logarithmic averaging.

In the case of averaging, P_{A} (P_{A} NOMA) to be used is calculated, for example, as P_{A}_NOMA=(P_{A}1+P_{A}2)/2.

In the case of weighted averaging, P_{A} (P_{A}_NOMA) to be used is calculated, for example, as P_{A}_NOMA=(α×P_{A}1+β×P_{A}2)/(α+β). Here, α and β represent weighting factors.

### Example 6

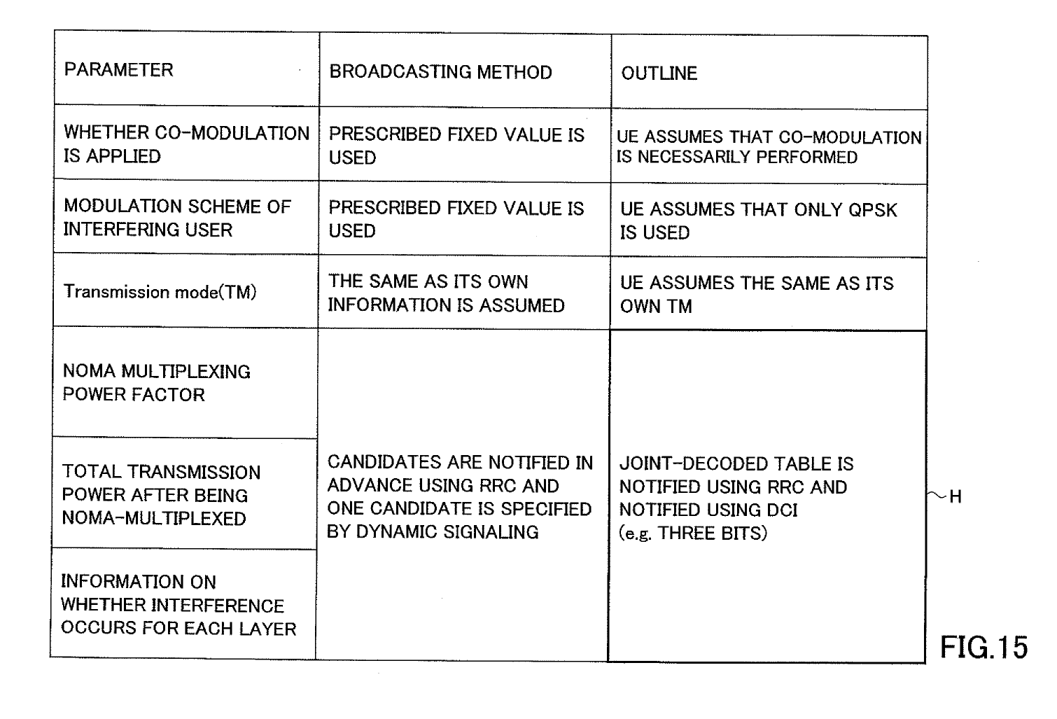

Example 6 will be described below. FIG. 15 is a diagram illustrating parameter notification methods according to Example 6 and operation examples of a UE side corresponding to the notification methods. In Example 6, the information on whether simultaneous modulation is applied, the modulation scheme of an interfering user, and the transmission mode are the same as in Examples 1 and 2.

In Example 6, the eNB notifies the UE of joint candidates of the “NOMA multiplexing power factor, the total transmission power after being NOMA-multiplexed, and the information on whether interference occurs for each layer” in advance using RRC signaling, and the UE specifies a combination of values to be used by dynamic signaling.

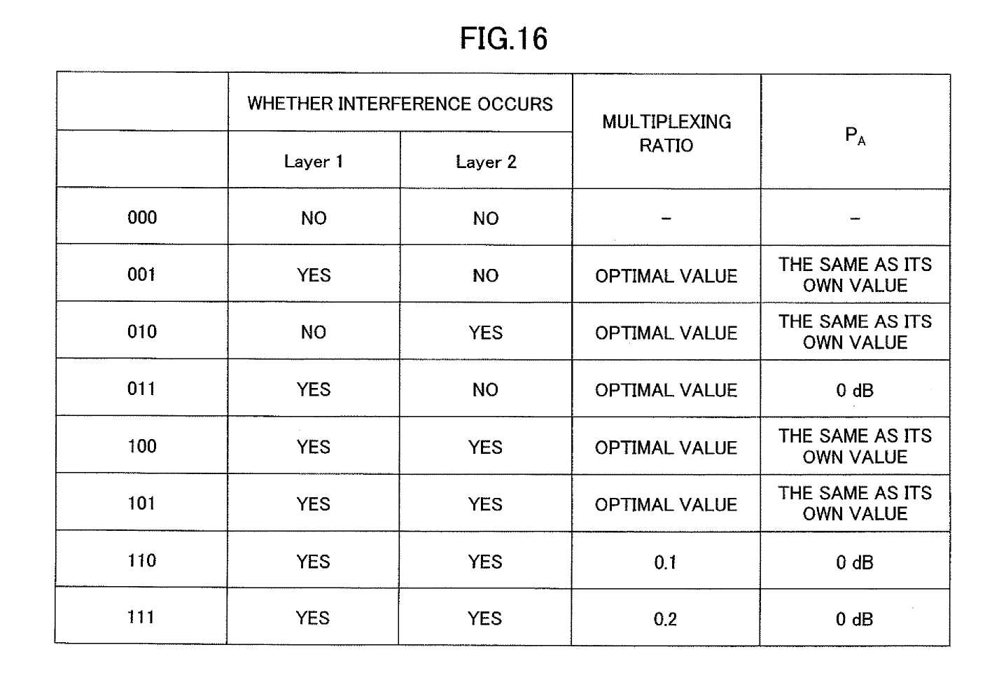

More specifically, the eNB transmits a jointly-decoded table to the UE using RRC signaling. Example of the table is illustrated in FIG. 16. The eNB transmits information indicating a specific combination (three bits in the example illustrated in FIG. 16) to the UE.

### Example 7

Example 7 will be described. In Example 7, an example of a detailed notification method when interference information is dynamically notified from the eNB to the UE using DCI (PDCCH) will be described.

In Example 7, the interference information which is dynamically notified includes the multiplexing power factor and the information on whether interference occurs for each layer (hereinafter referred to as rank information), but these are only an example and other information (for example, P_{A} of an interfering UE) may be dynamically notified in addition to the multiplexing power factor and the rank information. As interference information which is not dynamically notified, for example, a prescribed fixed value is used as described above. For example, it is assumed that simultaneous modulation is always performed, the modulation scheme of an interfering user is QPSK, and the TM of the interfering user is the same as its own TM.

As the multiplexing power factor which is dynamically notified, a value of the multiplexing power factor may be directly notified as described above, or candidates thereof may be notified using RRC signaling and a value to be actually used among the candidates may be designated using DCI.

As the signaling method using DCI, Example 7 basically uses the following options. As will be described later, Option 1 and Option 2/3 may be combined.

Option 1: Existing DCI is extended and the interference information is transmitted (the UE decodes one type of DCI).

Option 2: The existing DCI is not changed and new UE specific DCI including the interference information is transmitted (the UE decodes two types of DCI).

Option 3: The existing DCI is not changed and new common DCI including the interference information is transmitted (a terminal decodes two types of DCI).

In Examples 1 to 6, Option 1 is assumed when notification is performed using DCI. Existing DCI may be referred to as DCI for transmitting resource allocation information of a desired signal. Here, when the multiplexing power factor and/or the rank are changed for each sub-band depending on the scheduling in the eNB, NOMA gain can be improved. However, since signaling overhead for the interference information notification increases, it is preferable that signaling using new DCI as in Option 2/3 be performed. The sub-band is, for example, a bandwidth when a system bandwidth of a DL is divided into a predetermined number of sub-bands.

On the other hand, when the multiplexing power factor and/or the rank are not changed for each sub-band, the NOMA gain decreases but the signaling overhead decreases. Accordingly, it is preferable that Option 1 in which the existing DCI is extended be used.

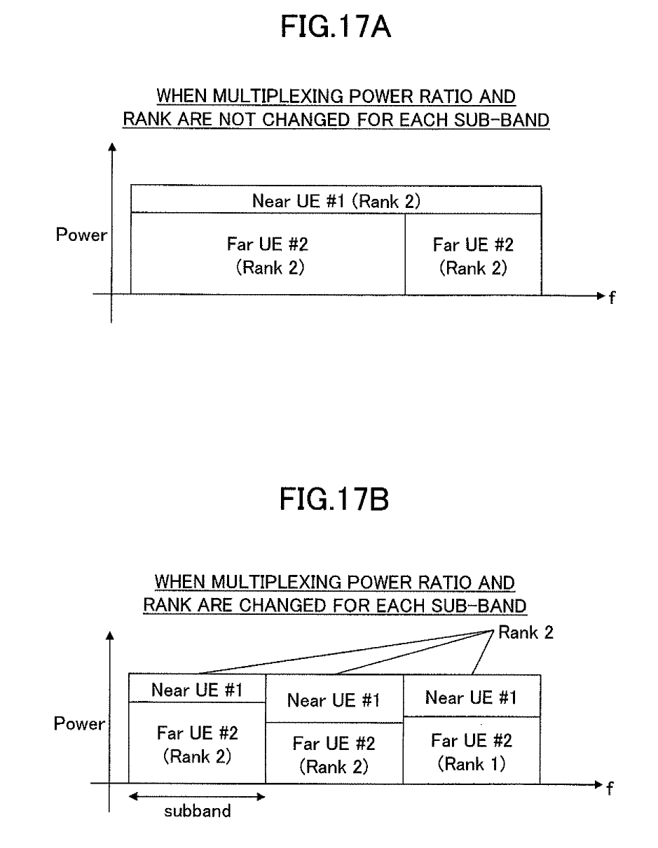

The above-mentioned details are illustrated in FIGS. 17A and 17B. FIG. 17A illustrates a case in which the multiplexing power factor and/or the rank are not changed for each sub-band. In the example illustrated in FIG. 17A, the multiplexing power factor and the rank are constant in the system bandwidth in scheduling from the eNB to the UEs. In this case, since a degree of freedom in scheduling is low but it is not necessary to transmit the multiplexing power factor and/or the rank information for each sub-band, the overhead decreases.

FIG. 17B illustrates a case in which the multiplexing power factor and/or the rank are changed for each sub-band. In this case, since the degree of freedom in scheduling is high but it is necessary to transmit the multiplexing power factor and/or the rank information for each sub-band, the overhead increases in comparison with the case illustrated in FIG. 17A.

That is, the signaling overhead and the NOMA gain have a trade-off relationship with each other.

In Example 7, Option 1 and Option 2/3 can be flexibly changed in consideration of the above-mentioned description.

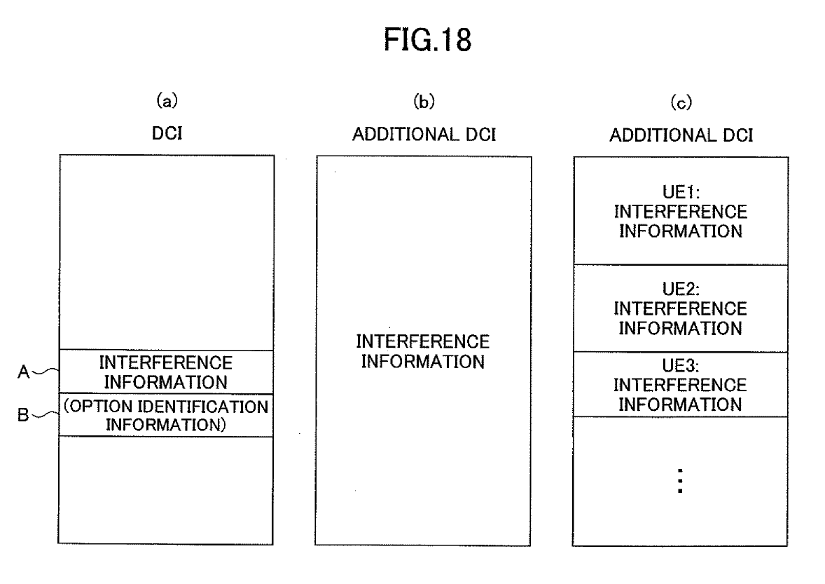

FIG. 18 is a diagram illustrating an example of information which is stored in DCI in Example 7. FIG. 18(a) corresponds to Option 1, and existing DCI is extended and includes interference information (for example, the multiplexing power factor and the rank information) indicated by A. Option identification information indicated by B is information which is added in Example 7-3 to be described later, and the option identification information indicated by B is not included in Examples 7-1 and 7-2 other than Example 7-3. In Example 7-3, when Option 2/3 is applied, the interference information indicated by A in FIG. 18(a) may not be included. As will be described in Example 7-3, even when Option 2/3 is applied, the interference information indicated by A in FIG. 18(a) may be included.

FIG. 18(b) corresponds to Option 2 and illustrates new DCI including interference information. The DCI is DCI which is specific to a UE that detects the DCI. FIG. 18(c) corresponds to Option 3 and illustrates new DCI including interference information. The DCI is DCI which is common to a plurality of UEs that detect the DCI. For example, the DCI includes interference information of a plurality of UEs and each UE acquires its own interference information.

Regarding Option 2 and Option 3, in the radio communication system, any one of Option 2 and Option 3 may be performed or both may be performed. When any one is performed, a UE searches for additional DCI of Option 2, for example, using UE-specific identifier (RNTI) or searches for additional DCI of Option 3 using UE-common identifier (RNTI for additional DCI). When both options are performed, a UE searches for additional DCI of Option 2 using a UE-specific identifier (RNTI), searches for additional DCI of Option 3 using a UE-common identifier (RNTI for additional DCI), and acquires its own interference information from any one additional DCI. In the following description, description of “Option 2/3” means “only Option 2,” “only Option 3,” or “Options 2 and 3.”

Example 7-1, Example 7-2, and Example 7-3 will be described below as a specific operation example in which Option 1 and Option 2/3 can be flexibly changed.

### Example 7-1

First, Example 7-1 will be described. In Example 7-1, the options are designated by information (configuration information) transmitted from the eNB to the UE using RRC signaling.

When the eNB limits the multiplexing power factor and the rank information in scheduling (that is, when they are kept constant in the system bandwidth), the eNB transmits information indicating that interference information notification based on Option 1 is performed to the UE using RRC signaling (upper layer signaling). The UE receiving the information using the RRC signaling performs an operation of acquiring the interference information in accordance with Option 1. That is, for example, the UE acquires a desired signal by detecting (decoding) existing DCI (extended DCI) using C-RNTI, acquiring the interference information from the DCI, and performing interference cancelling using the interference information.

The information which is notified using the upper layer signaling is not particularly limited as long as it is information which can be used to determine an option to be used. For example, the information may be information indicating whether Option 1 is designated or information indicating which option is used. Alternatively, information associated with an option may be signaled. For example, information in Cases 1 to 3 described in Non-Patent Document 3 may be signaled. In this case, the UE may determine that Option 1 is designated, for example, in Case 1 and Case 2 and may determine that Option 2/3 is designated in Case 3.

As described as “Case 1: Superposed PDSCHs are transmitted using the same transmission scheme and the same spatial precoding vector; Case 2: Superposed PDSCHs are transmitted using the same transmit diversity scheme; Case 3: Superposed PDSCHs are transmitted using the same transmission scheme, but their spatial precoding vectors are different” in Non-Patent Document 3, Case 1 is a case in which superposed PDSCHs are transmitted using the same transmission scheme and the same spatial precoding vector, Case 2 is a case in which superposed PDSCHs are transmitted using the same transmit diversity scheme, and Case 3 is a case in which superposed PDSCHs are transmitted using the same transmission scheme but different spatial precoding vectors.

When the eNB does not limit the multiplexing power factor and/or the rank information in scheduling (that is, when they can be changed for each sub-band), the eNB transmits information indicating that interference information notification based on Option 2/3 is performed to the UE using RRC signaling. The UE receiving the information using the RRC signaling performs an operation of acquiring the interference information in accordance with Option 2/3. That is, for example, the UE acquires a desired signal by detecting (decoding) the DCI using RNTI for addition DCI, acquiring the interference information from the DCI, and performing interference cancelling using the interference information.

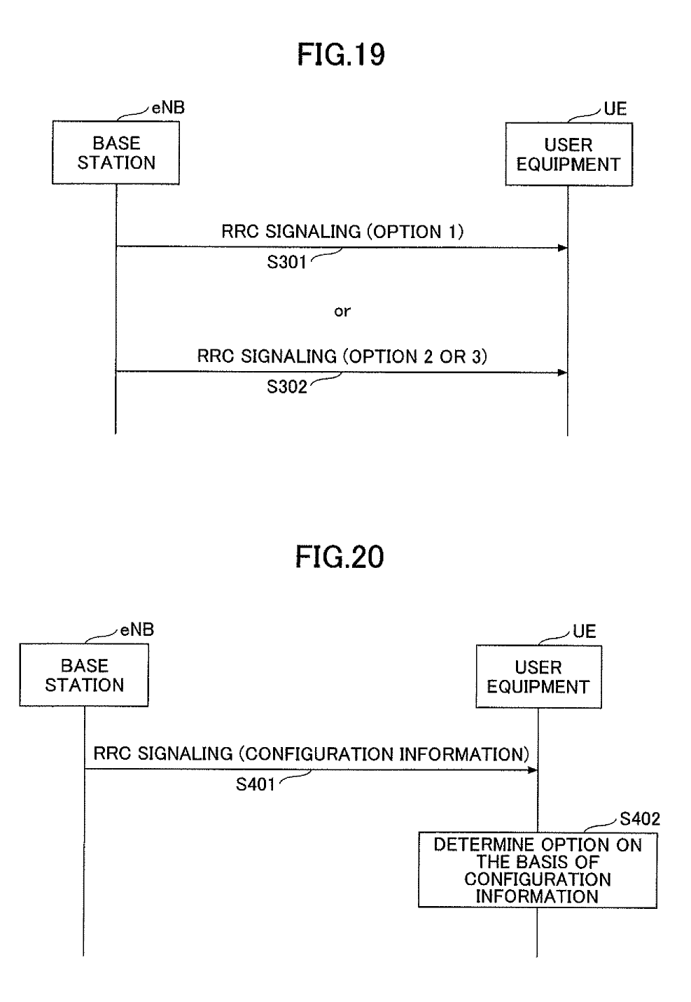

FIG. 19 is a sequence diagram in Example 7-1. As illustrated in FIG. 19, the UE performs an operation based on Option 1 when RRC signaling indicating Option 1 is received from the eNB (Step S301). The UE performs an operation based on Option 2/3 when RRC signaling indicating Option 2/3 is received from the eNB (Step S302).

In Example 7-1, since RRC signaling which is semi-static is used, it is possible to relatively easily perform implementation thereof.

### Example 7-2

Example 7-2 will be described below. In Example 7-2, a UE construes that information configured in advance by RRC signaling from the eNB is information indicating an option and determines the option to be applied on the basis of the information.

Examples of the configuration information which is used to determine an option include information on a transmission mode (TM) and information on a CQI reporting mode. These are only an example and other configuration information may be used as the information for determining an option.

When the TM information is used as the information for determining an option, for example, the UE determines that Option 1 is applied when the configured TM is a CRS-based TM (TM1 to TM6), and determines that Option 2/3 is applied when the configured TM is a DMRS-based TM (TM7 to TM10). The eNB determines the same, performs interference information notification in which Option 1 is applied to the UE when the CRS-based TM (TM1 to TM6) is configured for the UE, and performed interference information notification in which Option 2/3 is applied to the UE when the DMRS-based TM (TM7 to TM10) is configured for the UE.

When the CQI reporting mode information (see Table 7.2.1-1, 7.2.2-1, and the like in Non-Patent Document 2) is used as the information for determining an option, for example, the UE determines that Option 1 is applied when wideband CQI is configured (that is, when Mode 1-0, 1-1, or 1-2 is configured), and determines that Option 2/3 is applied when the other mode (sub-band CQI) is configured. The eNB determines the same, performs interference information notification in which Option 1 is applied to the UE when the wideband CQI is configured for the UE, and performs interference information notification in which Option 2/3 is applied to the UE when the sub-band CQI is configured for the UE.

As described above, the UE determining that Option 1 is applied on the basis of the configuration information performs an operation of acquiring interference information in accordance with Option 1. That is, for example, the UE detects (decodes) existing DCI (extended DCI) using the C-RNTI, acquires the interference information from the DCI, and acquires a desired signal by performing interference cancelling using the interference information.

The CE determining that Option 2/3 is applied on the basis of the setting information performs an operation of acquiring interference information in accordance with Option 2/3. That is, for example, the UE detects (decodes) the DCI using the RNTI for additional DCI, acquires the interference information from the DCI, and acquires a desired signal by performing interference cancelling using the interference information.

FIG. 20 is a sequence diagram in Example 7-2. As illustrated in FIG. 20, the UE receives RRC signaling including general configuration information (configuration information) from the eNB (Step S401). The configuration information is configured (stored) in the UE. The configuration information includes the TM information, the CQI reporting mode information, and the like. The UE determines an option to be applied on the basis of the configuration information (Step S402).

In Example 7-2, since RRC signaling which is semi-static is used, it is possible to relatively easily perform implementation thereof. It is also possible to suppress an increase in overhead of the RRC signaling.

### Example 7-3

Example 7-3 will be described below. In Example 7-3, Option 1 and Option 2/3 are combined. As described above with reference to FIG. 18(a), information indicating an option to be applied is included in the existing DCI (extended DCI). When Option 1 is applied, interference information is additionally included in the existing DCI (extended DCI) as illustrated in FIG. 18(a). When Option 2/3 is applied, the UE acquires (decodes) additional DCI and acquires interference information from the addition DCI.

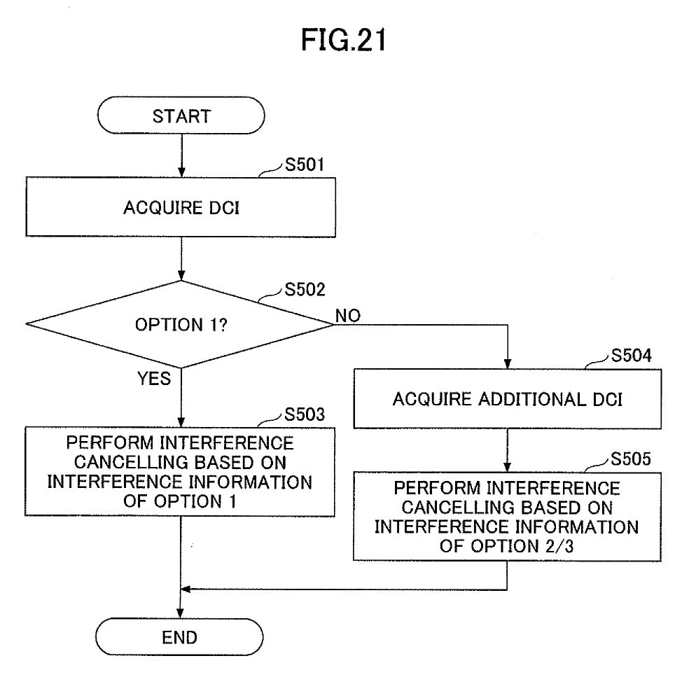

The basic operation of the UE in Example 7-3 will be described below with reference to the flowchart illustrated in FIG. 21.

First, the UE acquires existing DCI (extended DCI) transmitted from the eNB (Step S501). The UE reads information indicating an option from the DCI and determines an option to be applied to the UE on the basis of the read information (Step S502).

When the option to be applied is Option 1, the UE acquires interference information from the DCI acquired in Step S501, performs interference cancelling on the basis of the acquired interference information, and acquires a desired signal (Step S503). The interference information is interference information on the assumption that the multiplexing power factor and/or the rank information are limited (for example, the multiplexing power factor and the rank information are constant in the system bandwidth).

When the option to be applied is not Option 1 (when the option to be applied is Option 2/3), the UE acquires (decodes) additional DCI (Step S504), acquires the interference information from the DCI, and acquires a desired signal by performing interference cancelling using the interference information (Step S505). The interference information is interference information on the assumption that the multiplexing power factor and/or the rank information are not limited (for example, the multiplexing power factor and/or the rank information are variable for each sub-band).

When Option 2/3 is applied, for example, the eNB does not include the multiplexing power factor and the rank information in the existing DCI (DCI for notifying of the option) but includes the multiplexing power factor and the rank information in additional DCI. In this case, the multiplexing power factor and the rank information are read from the additional DCI and are used by the UE.

When Option 2/3 is applied, for example, the eNB may not only include the multiplexing power factor and the rank information in the existing DCI (DCI for notifying of the option) but also include the multiplexing power factor and the rank information in additional DCI. In this case, the sum of the multiplexing power factor and the rank information in the existing DCI and the multiplexing power factor and the rank information in the additional DCI is the multiplexing power factor and the rank information which are required for the UE to cancel interference. That is, the interference information in the additional DCI is a difference obtained by subtracting the interference information in the existing DCI from the interference information required by the UE.

According to Example 7-3, it is possible to dynamically change the option and to more flexibly select an option depending on scheduling or the like.

### Example 7-3, Option Designating Method

As described above, in Example 7-3, information for designating an option is included in the existing DCI (extended DCI). The designation method includes several variations, which will be described below in Examples 7-3-1 to 7-3-5.

### Example 7-3-1

In Example 7-3-1, information indicating the rank of a desired signal (the number of transmission layers) which is notified using DCI is used as the information for designating an option which is included in the existing DCI (extended DCI). For example, the UE applies Option 1 when it is detected using the DCI that the rank of the desired signal is 1. The UE applies Option 2/3 when it is detected using the DCI that the rank of the desired signal is 2 or greater. The eNB determines the same, performs the interference information notification in which Option 1 is applied to the UE when the rank of 1 is notified to the UE, and performs the interference information notification in which Option 2/3 is applied to the UE when the rank of 2 (or 2 or greater) is notified to the UE.

The method which is used for the UE to determine the rank is not limited to a specific method, and the UE can determine the rank, for example, on the basis of a DCI format. For example, the UE determines that the rank is 1 (Option 1 is applied in the above-mentioned example) when the DCI format is based on DCI format 1 series, and determines that the rank is 2 (Option 2/3 is applied in the above-mentioned example) when the DCI format is based on DCI format 2 series (see Table 7.1-5 in Non-Patent Document 2).

Information such as MCS of two codewords is included in the DCI format 2 series and disable of each codeword can be notified using the value of the MCS. Specifically, as described in Non-Patent Document 2, when a redundancy version is 1 and the MCS is 0, the corresponding codeword is disabled.

Therefore, the UE can determine that the rank is 1 when DCI of DCI format 2 series is received and any of two codewords is disabled. The UE can determine that the rank is 2 when any thereof is not disabled.

### Example 7-3-2

In Example 7-3-2, the UE construes (replaces) that existing information included in the existing DCI (extended DCI) is the information for designating an option and determines the option to be applied.

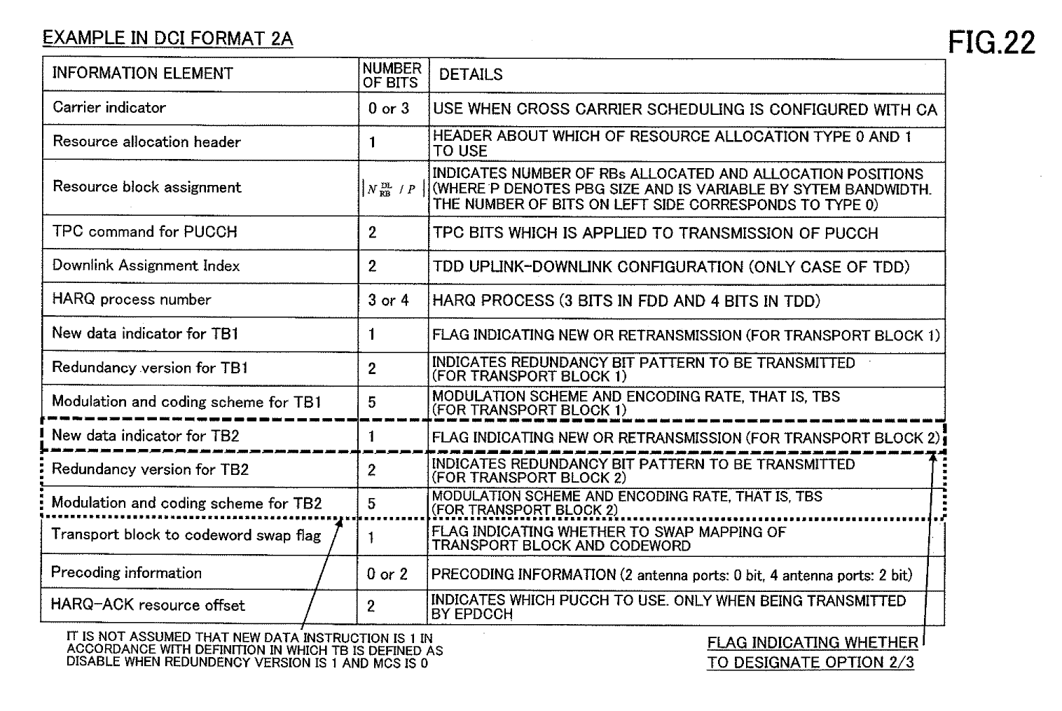

An example will be described below with reference to FIG. 22. FIG. 22 illustrates DCI format 2A. As illustrated in FIG. 22, in DCI format 2A, it is defined that the corresponding TB is disable when a redundancy version is 1 and the MCS is 0. That is, when the redundancy version in a certain TB is 1 and the MCS thereof is 0, it is not assumed that a new data indicator of the TB is 1. Therefore, when DCI format 2A is received, the UE determines, for example, that Option 1 is applied when the redundancy version in a certain TB in DCI format 2A is 1, the MCS thereof is 0, and the new data indicator is 1. Otherwise, the UE determines that Option 2/3 is applied. The determination mentioned above is an example, and it may be determined that Option 2/3 is applied when the redundancy version in a certain TB is 1, the MCS thereof is 0, and the new data indicator of the TB is 1, and that Option 1 is applied otherwise.

The eNB determines the same and, for example, the eNB transmits DCI in which a new data indicator of a certain TB is 1, for example, when Option 1 is applied to the UE, the redundancy version in the certain TB is 1, and the MCS thereof is 0.

### Example 7-3-3

In Example 7-3-3, a UE determines the option to be applied on the basis of a bandwidth (the number of RBs) of a desired signal which is allocated to the UE using existing DCI (extended DCI). For example, the UE determines that Option 1 is applied when an allocated bandwidth is less than 15 RBs, and determines that Option 2/3 is applied when the allocated bandwidth is equal to or greater than 15 RBs. “15 RBs” are an example.

The eNB determines the same, performs interference information notification in which Option 1 is applied to the UE when a bandwidth of less than 15 RBs is allocated to the UE, and performs interference information notification in which Option 2/3 is applied to the UE when a bandwidth of equal to or greater than 15 RBs is allocated to the UE.

### Example 7-3-4

In Example 7-3-4, a UE determines an option to be applied depending on whether DCI received from the eNB is DCI designating retransmission. In this case, the eNB applies the same option as in first transmission to the retransmission.

For example, the UE applies the option designated by the DCI when it is detected that DCI designates first (initial) transmission (when a new data indicator (NDI) is a value indicating first transmission), and applies the option used in the first transmission when it is detected that DCI designates retransmission (when a new data indicator (NDI) is a value indicating retransmission).

### Example 7-3-5

In Example 7-3-5, a UE determines an option on the basis of MCS information of a desired signal which is designated by existing DCI (extended DCI).

For example, the UE applies Option 2/3 when it is detected that the DCI designates QPSK or 16 QAM, and applies Option 1 when it is determined that 64 QAM is designated. When multiplicity is large like 64 QAM, robustness to interference decreases. Accordingly, since it is thus assumed that the multiplexing power factor and/or the rank information for each sub-band are not changed, Option 1 is applied.

Information of the rank may be used together. For example, the UE applies Option 1 when it is detected that DCI designates the rank of 2 and the 64 QAM, and applies Option 2/3 otherwise.

The eNB determines the same, performs interference information notification in which Option 2/3 is applied to the UE when the QPSK or the 16 QAM is designated for the UE, and performs interference information notification in which Option 1 is applied to the UE when the 64 QAM is designated for the UE.

### Example 7-4, Notification of Capability Information

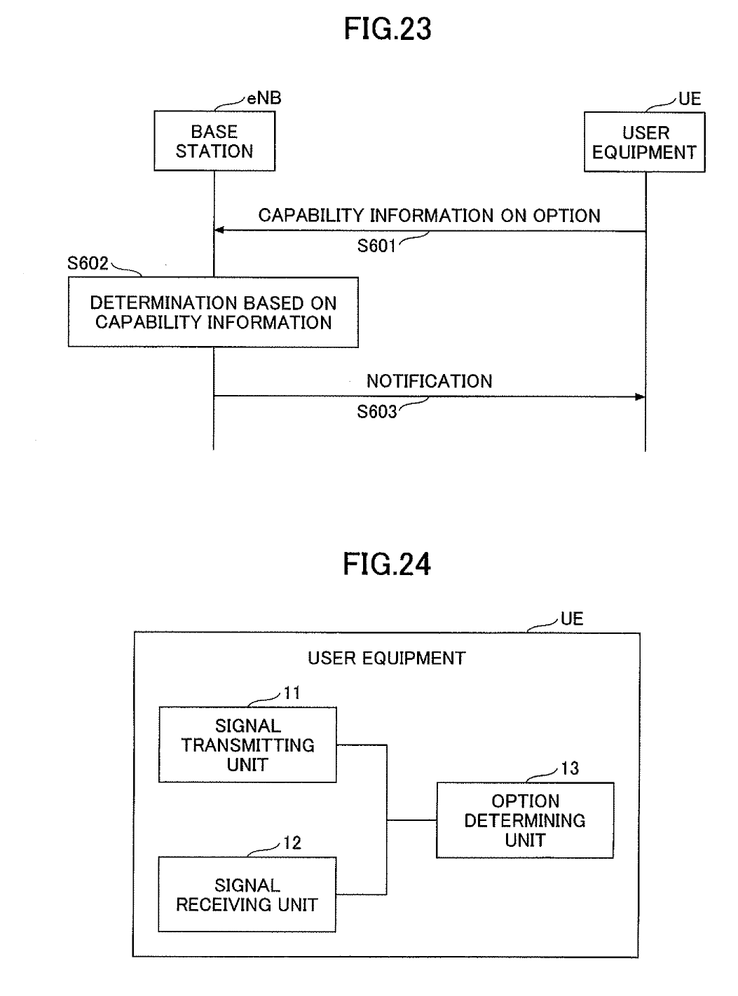

The eNB may determine which option should be applied to the UE on the basis of capability information (UE capability) received from the UE. Example 7-4 can be applied to any of Examples 7-1 to 7-3. An operation example will be described below with reference to the sequence diagram illustrated in FIG. 23.

A UE transmits capability information to the eNB (Step S601). The capability information includes information of an option supported by the UE (only Option 1 is supported, Option 1 and Option 2/3 are supported, only Option 2/3 is supported, or the like).

The eNB determines an option to be applied to the UE on the basis of the capability information received from the UE (Step S602). For example, the eNB determines that Option 1 is applied when the UE supports only Option 1, and determines that Option 2/3 is applied when the UE supports only Option 2/3. The eNB determines an option, for example, using the above-mentioned method (for example, MCS or a bandwidth) when the UE supports Option 1 and Option 2/3.

The eNB notifies the UE of the option determined in Step S602 (Step S603). This notification may be performed using RRC signaling or may be performed using DCI as described above.

In Example 7-4, the eNB can perform option notification depending on capability of the US.

(Device Configuration)

An example of functional configurations of a UE and an eNB that perform the above-mentioned operations according to the embodiment will be described below. The UE and the eNB have all the functions (which include Examples 1 to 7) described in the embodiment. The UE and the eNB may have some functions (for example, Example 7) of all the functions described in the embodiment.

<UE: User Equipment>

FIG. 24 is a diagram illustrating an example of a functional configuration of a UE. As illustrated in FIG. 24, a UE includes a signal transmitting unit 11, a signal receiving unit 12, and an option determining unit 13. The functional configuration illustrated in FIG. 24 is only an example. The functional subdivision and the names of the functional units are not particularly limited as long as the operations associated with the embodiment can be performed. For example, the option determining unit 13 may be included in the signal receiving unit 12.

The signal transmitting unit 11 is configured to generate a signal of a lower layer from information of an upper layer and to wirelessly transmit the generated signal. The signal receiving unit 12 is configured to wirelessly receive various signals and to acquire information of an upper layer from the received signals. The option determining unit 13 determines an option as described above in Example 7.

More specifically, the signal transmitting unit 11 transmits, for example, the capability information described above in Example 7. The signal receiving unit 12 receives control information which is used to acquire a desired signal from a multiplexed signal into which signals of a plurality of users are multiplexed in the power domain from the eNB by a downlink physical control channel and acquires the desired signal from the multiplexed signal using the control information. A desired signal acquiring unit that acquires the desired signal from the multiplexed signal using the control information may be disposed inside the signal receiving unit 12, or the desired signal acquiring unit may be disposed outside the signal receiving unit 12.

The signal receiving unit 12 can receive configuration information indicating the method of notifying of the control information from the eNB using upper layer signaling and can receive the control information on the basis of the configuration information. The signal receiving unit 12 may receive the control information on the basis of the notification method designated by information included in downlink control information received by the downlink physical control channel.

<eNB: Base Station>

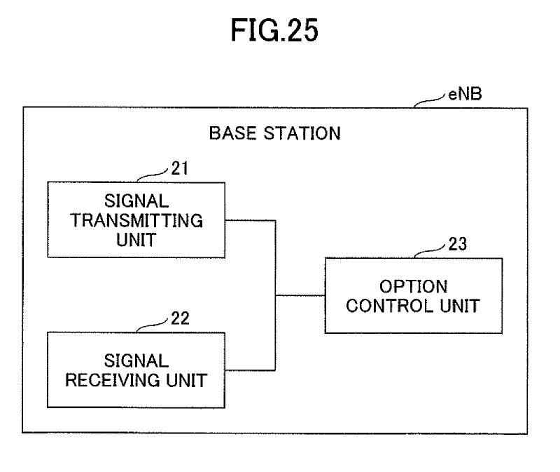

FIG. 25 is a diagram illustrating an example of a functional configuration of an eNB. As illustrated in FIG. 25, an eNB includes a signal transmitting unit 21, a signal receiving unit 22, and an option control unit 23. The functional configuration illustrated in FIG. 25 is only an example. The functional subdivision and the names of the functional units are not particularly limited as long as the operations associated with the embodiment can be performed. For example, the option control unit 23 may be included in the signal transmitting unit 21.

The signal transmitting unit 21 is configured to generate a signal of a lower layer from information of an upper layer and to wirelessly transmit the generated signal. The signal receiving unit 22 is configured to wirelessly receive various signals and to acquire information of an upper layer from the received signals. The option control unit 23 determines an option as described above in Example 7 and instructs the signal transmitting unit 21 to broadcast the determined option. The signal transmitting unit 21 transmits the option in accordance with the instruction to the UE. The signal transmitting unit 21 transmits interference information using a notification method corresponding to the broadcasted option.

<Example of Other Configuration of eNB and UE>

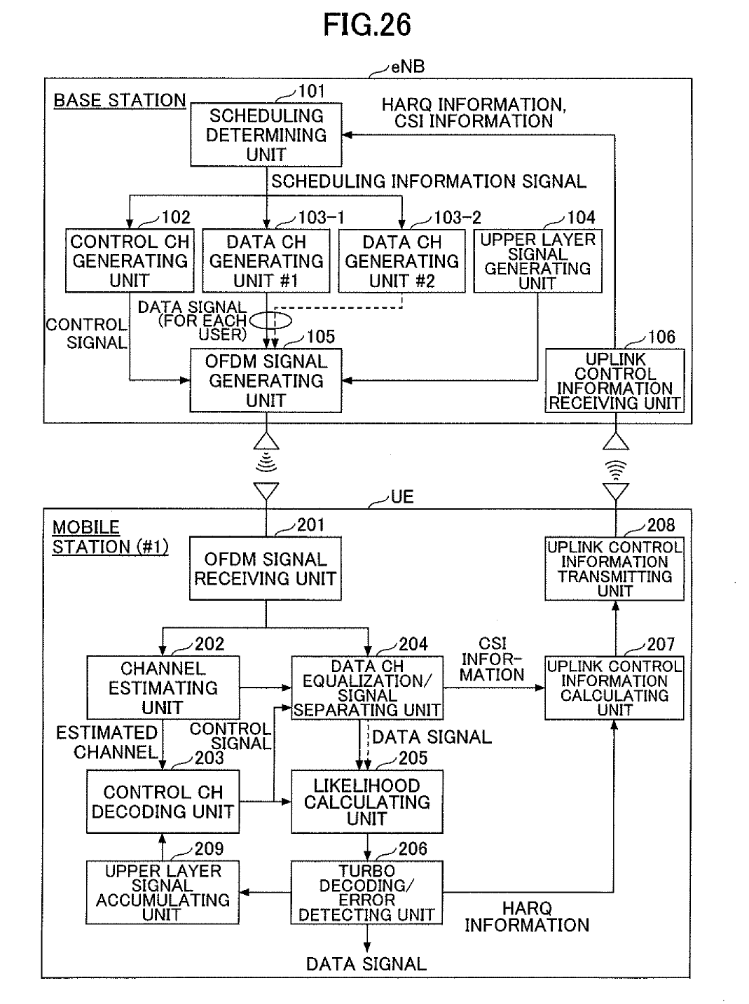

FIG. 26 illustrates an example of other configurations of the eNB and the UE in the embodiment. In the example illustrated in FIG. 26, it is assumed that user equipment (UE) #1 and user equipment #2 constitutes a pair to be NOMA-multiplexed, and only user equipment #1 (mobile station #1) is illustrated.

As illustrated in FIG. 26, the eNB includes a scheduling determining unit 101, a control channel (CH) generating unit 102, a data CH generating unit #1 (103-1), a data CH generating unit #2 (103-2), an upper layer signal generating unit 104, an OFDM signal generating unit 105, and an uplink control information receiving unit 106.

The scheduling determining unit 101 determines whether NOMA multiplexing is performed on frequency resources, the modulation schemes and the number of transmission layers of the UEs, the multiplexing power factor, the total transmission power, the TM, whether simultaneous modulation is applied, and the option (Option 1, Option 2/3, or the like) of interference information on the basis of HARQ information and CSI information fed back from the UEs. As for a parameter which is determined to be fixed in advance, it is not necessary to perform such determination. For example, when simultaneous modulation is always applied, it is not necessary to determine whether simultaneous modulation is applied.

The control CH generating unit 102 determines control CH information (DCI) on the basis of the information determined by the scheduling determining unit 101. The control CH generating unit 102 also has a function of including information designating an option in the DCI. When Example 7-1 is carried out, the upper layer signal generating unit 104 may determine an option and include information designating the option in the upper layer signaling.

The data CH generating units #1 and #2 (103-1 and 103-2) generate data signals of the UEs #1 and #2 on the basis of the modulation scheme, the number of transmission layers, and the TM determined by the scheduling determining unit 101.

The OFDM signal generating unit 105 combines the control CH, the data CH of each UE, and the upper layer signal information (RRC signaling) to generate an OFDM signal (in the time domain) and transmits the generated OFDM signal. When NOMA multiplexing is performed, the OFDM signal generating unit 105 combines the data CHs of the UEs in consideration of the multiplexing power factor, the total transmission power, and the information on whether simultaneous modulation is applied. The uplink control information receiving unit 106 receives uplink control information (HARQ information, CSI information) from the UEs. The uplink control information receiving unit 106 also receives the capability information transmitted from the UEs.

As illustrated in FIG. 26, the UE includes an OFDM signal receiving unit 201, a channel estimating unit 202, a control CH decoding unit 203, a data CH equalization/signal separating unit 204, a likelihood calculating unit 205, a turbo decoding/error detecting unit 206, an uplink control information calculating unit 207, an uplink control information transmitting unit 208, and an upper layer signal accumulating unit 209.

The OFDM signal receiving unit 201 receives an OFDM signal (in the time domain) and converts the OFDM signal into a signal in the frequency domain using FFT or the like. The channel estimating unit 202 estimates a channel from the received signal (in the frequency domain). The control CH decoding unit 203 decodes downlink control CH information (DCI) (including interference information in Example 7 or the like) from the received signal and the channel estimation information. As described above in the examples, the control CH decoding unit 203 determines the number of bits of the DCI, for example, depending on whether an upper layer signal is present in the interference information notification and performs decoding. As described above in Example 7, the control CH decoding unit 203 performs acquisition of interference information from existing DCI and/or acquisition of interference information from additional DCI.

The data CH equalization/signal separating unit 204 performs channel equalization/signal separation of a data CH from the received signal, the channel estimation information, and the control CH information. When NOMA multiplexing is performed, a receiving process on the assumption of multi-user is performed.

The likelihood calculating unit 205 calculates likelihood information (LLR) of a desired signal on the basis of the equalized/separated signal. When NOMA multiplexing is performed, the likelihood is calculated on the basis of optimal signal points depending on whether simultaneous modulation is applied or the like.

The turbo decoding/error detecting unit 206 performs turbo decoding and performs error detection. The uplink control information calculating unit 207 calculates downlink CSI information (CQI, PMI, RI) from the received signal. HARQ information (ACK/NACK) is calculated from the turbo detection result.

The uplink control information transmitting unit 208 transmits the above-mentioned uplink control signal to the eNB. The upper layer signal accumulating unit 209 accumulates (stores) an upper layer signal (for example, parameter notified using RRC) and sends the upper layer signal to the control CH decoding unit 203. For example, when an option is notified using the upper layer signal, the control CH decoding unit 203 acquires interference information on the basis of option information sent from the upper layer signal accumulating unit 209.

<Hardware Configuration>

The block diagrams (FIGS. 24 to 26) which are used above to describe the embodiments illustrate blocks in the units of functions. The functional blocks (constituent units) are embodied in an arbitrary combination of hardware and/or software. Means for embodying the functional blocks is not particularly limited. That is, the functional blocks may be embodied by one unit which is physically and/or logically coupled or may be embodied by two or more units which are physically and/or logically separated and which are connected directly and/or indirectly (for example, in a wired and/or wireless manner).

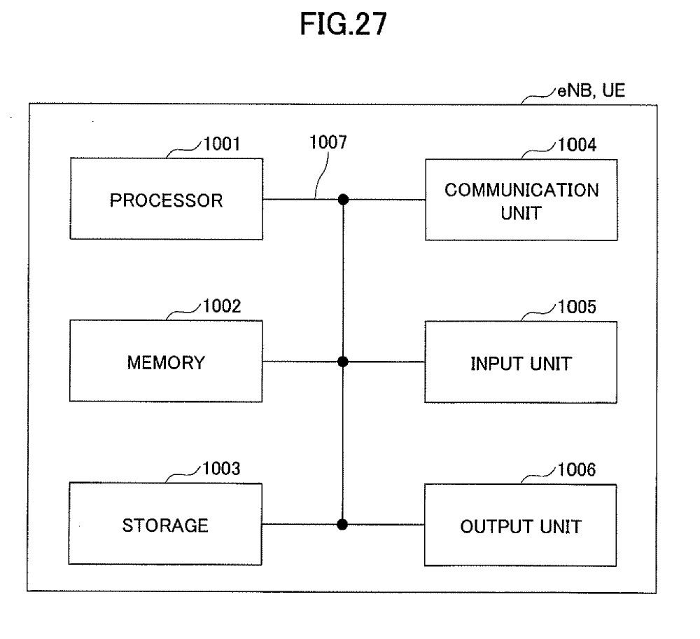

For example, the UE and the eNB in the embodiments may function as computers that perform the processes of the signal receiving method according to the invention. FIG. 27 is a diagram illustrating an example of a hardware configuration of the UE and the eNB according to the invention. The UE and the eNB may be physically configured as a computer device including a processor 1001, a memory 1002, a storage 1003, a communication unit 1004, an input unit 1005, an output unit 1006, and a bus 1007.

In the following description, a word “unit” may be referred to as a circuit, a device, a unit, or the like. The hardware configurations of the UE and the eNB may include one or more units indicated by 1001 to 1006 illustrated in the drawing or may not include some units.

The functions of the UE and the eNB are realized by causing hardware such as the processor 1001 and the memory 1002 to read predetermined software (a program) and causing the processor 1001 to perform computation and to control communication of the communication unit 1004 and reading and/or writing of data in the memory 1002 and the storage 1003.

The processor 1001 controls the computer as a whole, for example, by activating an operating system. The processor 1001 may be constituted by a central processing unit (CPU) including an interface with peripherals, a control unit, a calculation unit, a register, and the like.

The processor 1001 reads a program (program codes), a software module, or data from the storage 1003 and/or the communication unit 1004 to the memory 1002 and performs various processes in accordance therewith. As the program, a program causing a computer to perform at least a part of the operations described above in the embodiment is used. For example, the signal transmitting unit 11, the signal receiving unit 12, and the option determining unit 13 of the UE illustrated in FIG. 24 may be embodied by a control program which is stored in the memory 1002 and operated by the processor 1001. For example, the signal transmitting unit 21, the signal receiving unit 22, and the option control unit 23 of the eNB illustrated in FIG. 25 may be embodied by a control program which is stored in the memory 1002 and operated by the processor 1001. Various processes described above have been described to be performed by a single processor 1001, but may be simultaneously or sequentially performed by two or more processors 1001. The processor 1001 may be mounted as one or more chips. The program may be transmitted from a network via an electric communication line.

The memory 1002 is a computer-readable recording medium and may be constituted, for example, by at least one of a read only memory (ROM), an erasable programmable ROM (EPROM), an electrically erasable programmable ROM (EEPROM), and a random access memory (RAM). The memory 1002 may be referred to as a register, a cache, or a main memory (a main storage unit). The memory 1002 can store a program (program codes), a software module, or the like which can be executed to perform the signal receiving method according to the embodiment.

The storage 1003 is a computer-readable recording medium and may be constituted, for example, by at least one of an optical disc such as a compact disc ROM (CD-ROM), a hard disk drive, a flexible disk, a magneto-optical disk (such as a compact disk, a digital versatile disk, or a Blu-ray (registered trademark) disk), a smart card, a flash memory (such as a card, a stick, or a key drive), a floppy (registered trademark) disk, and a magnetic strip. The storage 1003 may be referred to as an auxiliary storage unit. Examples of the recording medium may include a database including the memory 1002 and/or the storage 1003, a server, and another appropriate medium.

The communication unit 1004 is hardware (a transceiver device) that allows communication between computers via a wired and/or wireless network and is referred to as, for example, a network device, a network controller, a network card, or a communication module. For example, the signal transmitting unit 11 and the signal receiving unit 12 of the UE and the signal transmitting unit 21 and the signal receiving unit 22 of the eNB may be embodied by the communication unit 1004.

The input unit 1005 is an input device (such as a keyboard, a mouse, a microphone, a switch, a button, or a sensor) that receives an input from the outside. The output unit 1006 is an output device (such as a display, a speaker, or an LED lamp) that performs outputting to the outside. The input unit 1005 and the output unit 1006 may be configured as a unified body (such as a touch panel).

The units such as the processor 1001 and the memory 1002 are connected to each other via the bus 1007 for transmitting and receiving information. The bus 1007 may be constituted by a single bus or may be configured by different buses for the units.

The UE and the eNB may be configured to include hardware such as a microprocessor, a digital signal processor (DSP), an application specific integrated circuit (ASIC), a programmable logic device (PLD), or a field programmable gate array (FPGA), or a part or all of the functional blocks may be embodied by the hardware. For example, the processor 1001 may be mounted as at least one hardware module.

### Conclusion of Embodiments

According to the above-mentioned embodiments, there is provided a user equipment which is used in a radio communication system, the user equipment including: a receiver unit configured to receive control information, which is used to acquire a desired signal from a multiplexed signal into which a plurality of user signals are multiplexed in a power domain, from a base station via a downlink physical control channel; and a desired signal acquiring unit configured to acquire the desired signal from the multiplexed signal using the control information, in which the receiver unit receives configuration information indicating a notification method of the control information from the base station by upper layer signaling and receives the control information on the basis of the configuration information.

According to this configuration, it is possible to enable a user equipment to appropriately acquire control information which is used to acquire a desired signal from a received signal even when a notification method of control information is changed depending on scheduling. According to the configuration, the base station can flexibly change the notification method of control information depending on scheduling.

The configuration information, for example, indicates a first notification method of including the control information in first downlink control information for transmitting resource allocation information of the desired signal to the user equipment or a second notification method of including the control information in second downlink control information which is different from the first downlink control information. According to this configuration, it is possible to designate a notification method from a plurality of types of notification methods on the basis of the configuration information.

The configuration information is transmission mode information, CQI report mode information, or dedicated information indicating the notification method of the control information. It is possible to realize signaling with suppressed overhead by using the transmission mode information and the CQI report mode information as the configuration information. It is possible to flexibly switch the notification method by using dedicated information indicating the notification method.

According to the embodiment, there is provided a user equipment which is used in a radio communication system, the user equipment including: a receiver unit configured to receive control information, which is used to acquire a desired signal from a multiplexed signal into which a plurality of user signals are multiplexed in a power domain, from a base station via a downlink physical control channel; and a desired signal acquiring unit configured to acquire the desired signal from the multiplexed signal using the control information, in which the receiver unit receives the control information on the basis of a notification method indicated by information included in downlink control information received via the downlink physical control channel.

According to this configuration, it is possible to enable a user equipment to appropriately acquire control information which is used to acquire a desired signal from a received signal even when a notification method of control information is changed depending on scheduling. According to the configuration, the base station can flexibly change the notification method of control information depending on scheduling.

The receiver unit acquires the control information from the downlink control information using the notification method, acquires the control information from second downlink control information which is different from the downlink control information, or acquires the control information from the downlink control information and the second downlink control information. According to this configuration, the user equipment can appropriately acquire control information using various notification methods.

### Complement of Embodiment

While embodiments of the invention have been described above, the invention disclosed herein is not limited to the embodiments and it will be understood by those skilled in the art that various modifications, corrections, alternatives, substitutions, and the like can be made. While description has been made using specific numerical value examples for the purpose of promoting understanding of the invention, such numerical values are only simple examples and arbitrary appropriate values may be used unless otherwise specified. The sorting of items in the above description is not essential to the invention, details described in two or more items may be combined for use if necessary, or details described in a certain item may be applied to details described in another item (unless incompatible). Boundaries between functional units or processing units in the functional block diagrams cannot be said to be necessarily correspond to boundaries of physical components. Operations of a plurality of functional units may be physically performed by one component, or an operation of one functional unit may be physically performed by a plurality of components. The processing sequences described in the embodiments may be changed in the order as long as they are not incompatible with each other. For the purpose of convenience of description, while a UE and an eMB have been described above with reference to functional block diagrams, such devices may be embodied by hardware, by software, or by combination thereof. Software which is executed by a processor of the UE and software which is executed by a processor of the eNB in the embodiments of the invention may be stored in an appropriate storage medium such as a random access memory (RAM), a flash memory, a read only memory (ROM), an EPROM, an EEPROM, a register, a hard disk (HDD), a removable disk, a CD-ROM, a database, or a server.

Transmission of information is not limited to the aspects/embodiments described in this specification, but may be performed using other methods. For example, the transmission of information may be performed by physical layer signaling (such as downlink control information (DCI) or uplink control information (UCI)), upper layer signaling (such as radio resource control (RRC) signal, medium access control (MAC) signaling, or broadcast information (master information block (MIB) and system information block (SIB))), other signals, or combinations thereof. The RRC signaling may be referred to as an RRC message and may be, for example, an RRC connection setup message or an RRC connection reconfiguration message.

The aspects/embodiments described in this specification may be applied to systems employing long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), or other appropriate systems and/or next-generation systems to which the systems are extended.

The processing sequences, the sequences, the flowcharts, and the like of the aspects/embodiments described above in this specification may be changed in the order as long as they are not incompatible with each other. For example, in the methods described in this specification, various steps as elements are described in an exemplary order and the methods are not limited to the described order.

Specific operations which are performed by an eNB in this specification may be performed by an upper node thereof in some cases. In a network including one or more network nodes including a base station, various operations which are performed to communicate with a UE can be apparently performed by the eNB and/or network nodes (for example, an MME or an S-GW can be considered but the network nodes are not limited thereto) other than the eNB. A case in which the number of network nodes other than the eNB is one has been described above, but a combination of plural different network nodes (for example, an MME and an S-GW) may be used.

The aspects/embodiments described in this specification may be used alone, may be used in combination, or may be switched with implementation thereof.

A UE may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several appropriate terms by those skilled in the art.

The eNB may be referred to as a NodeB (NB), an enhanced NodeB (eNB), a base station, or several appropriate terms by those skilled in the art.

The terms “determining” and “determination” which are used in this specification may include various types of operations. The terms “determining” and “determination” may include that judging, calculating, computing, processing, deriving, investigating, looking up (for example, looking up in a table, a database, or another data structure), and ascertaining are considered to be “determined.” The terms “determining” and “determination” may include that receiving (for example, receiving of information), transmitting (for example, transmitting of information), input, output, and accessing (for example, accessing data in a memory) are considered to be “determined.” The terms “determining” and “determination” may include that resolving, selecting, choosing, establishing, and comparing are considered to be “determined.” That is, the terms “determining” and “determination” can include that a certain operation is considered to be “determined.”

An expression “on the basis of ˜” which is used in this specification does not refer to only “on the basis of only ˜,” unless apparently described. In other words, the expression “on the basis of ˜” refers to both “on the basis of only ˜” and “on the basis of at least ˜.”

So long as terms “include” and “including” and modifications thereof are used in this specification or the appended claims, the terms are intended to have a comprehensive meaning similar to a term “comprising.” A term “or” which is used in this specification or the claims is intended not to mean an exclusive logical sum.

In the entire disclosure, for example, when an article such as a, an, or the is added in translation into English, such an article refers to including the plural unless otherwise recognized from the context.

While the invention has been described above in detail, it will be apparent to those skilled in the art that the invention is not limited to the embodiments described in the specification. The invention can be modified and embodied as aspects changed without departing from the concept and scope of the invention which are defined by the appended claims. Accordingly, the description in this specification is made for illustrative description and does not have any restrictive meaning.

This application claims the benefit of Japanese Priority Patent Application JP 2016-215710 filed Nov. 2, 2016, and the entire contents of the Patent Application JP 2016-215710 are incorporated herein by reference.

### EXPLANATIONS OF LETTERS OR NUMERALS

eNB base station
21 signal transmitting unit
22 signal receiving unit
23 option control unit
101 scheduling determining unit
102 control CH generating unit
103 data CH generating unit #1 and #2
104 upper layer signal generating unit
105 OFDM signal generating unit
106 uplink control information receiving unit
UE user equipment
11 signal transmitting unit
12 signal receiving unit
13 option determining unit
201 OFDM signal receiving unit
202 channel estimating unit
203 control CH decoding unit
204 data CH equalization/signal separating unit
205 likelihood calculating unit
206 turbo decoding/error detecting unit
207 uplink control information calculating unit
208 uplink control information transmitting unit
209 upper layer signal accumulating unit
1001 processor
1002 memory
1003 storage
1004 communication unit
1005 input unit
1006 output unit

1. A user equipment which is used in a radio communication system, the user equipment comprising:
a receiver unit configured to receive control information, which is used to acquire a desired signal from a multiplexed signal into which a plurality of user signals are multiplexed in a power domain, from a base station via a downlink physical control channel; and
a desired signal acquiring unit configured to acquire the desired signal from the multiplexed signal using the control information,
wherein the receiver unit receives configuration information indicating a notification method of the control information from the base station by upper layer signaling and receives the control information on the basis of the configuration information.

2. The user equipment according to claim 1, wherein the configuration information indicates a first notification method of including the control information in first downlink control information for transmitting resource allocation information of the desired signal to the user equipment or a second notification method of including the control information in second downlink control information which is different from the first downlink control information.

3. The user equipment according to claim 1, wherein the configuration information is transmission mode information, CQI report mode information, or dedicated information indicating the notification method of the control information.

4. A user equipment which is used in a radio communication system, the user equipment comprising:
a receiver unit configured to receive control information, which is used to acquire a desired signal from a multiplexed signal into which a plurality of user signals are multiplexed in a power domain, from a base station via a downlink physical control channel; and
a desired signal acquiring unit configured to acquire the desired signal from the multiplexed signal using the control information,
wherein the receiver unit receives the control information on the basis of a notification method indicated by information included in downlink control information received via the downlink physical control channel.

5. The user equipment according to claim 4, wherein, according to the notification method, the receiver unit acquires the control information from the downlink control information, or acquires the control information from second downlink control information which is different from the downlink control information, or acquires the control information from the downlink control information and the second downlink control information.

6. A signal receiving method which is performed by a user equipment which is used in a radio communication system, the signal receiving method comprising:
a step of receiving configuration information indicating a notification method of control information, which is used to acquire a desired signal from a multiplexed signal into which a plurality of user signals are multiplexed in a power domain, from a base station upper layer signaling; and
a step of receiving the control information from the base station by a downlink physical control channel on the basis of the configuration information; and
a step of acquiring the desired signal from the multiplexed signal using the control information.

7. The user equipment according to claim 2, wherein the configuration information is transmission mode information, CQI report mode information, or dedicated information indicating the notification method of the control information.
